(19) United States
(12) Patent Application Publication
(10) Pub. No.: US 2025/0200282 A1
(43) Pub. Date: Jun. 19, 2025

(54) SYSTEMS AND METHODS FOR PREDICTING CONTENT MEMORABILITY

(71) Applicant: Adobe Inc., San Jose, CA (US)

(72) Inventors: Yaman Kumar, San Jose, CA (US); Somesh Singh, San Jose, CA (US); Harini Saravana Kumar Indumathi, Mumbai (IN); Balaji Krishnamurthy, San Jose, CA (US); Aanisha Bhattacharyya, San Jose, CA (US)

(73) Assignee: Adobe Inc., San Jose, CA (US)

(21) Appl. No.: 18/538,988

(22) Filed: Dec. 13, 2023

(51) Int. Cl. G06F 40/284; G06V 10/70; G06V 20/70

(52) U.S. Cl. CPC G06F 40/284; G06V 10/70; G06V 20/70

(57) ABSTRACT

Embodiments are generally directed to extending artificial intelligence (AI) and machine learning (ML) techniques to determine the memorability of visual content, including the long-term memorability of the visual content. One method of determining the memorability of visual content includes generating language tokens from the visual content. The language tokens represent the visual content in a language space and include visual encoding tokens computed by a visual encoding model and verbalization tokens computed by a verbalization model. A natural language processing (NLP) model, such as a pre-trained large language model (LLM), is trained using at least one memorability dataset to process the language tokens and determine a memorability prediction for the visual content. The memorability prediction includes a probability of the digital visual content being remembered by a viewer, for instance, over a long-term duration.

### BACKGROUND

Advancements in communication networks and computer processing have led to the proliferation of visual content access via consumer devices, particularly smart phones and tablet devices. In addition, improved development software has allowed content creators to generate highly sophisticated visual content easily and efficiently. A diverse array of industries, such as marketing, education, and entertainment, have taken advantage of visual content editing and distribution platforms to put more content in front of larger audiences than previously possible.

However, as a result of the surge in visual media distribution, users are inundated with visual information on a daily basis. As such, it is increasingly difficult for developers to create videos and/or images that stand out and are memorable. The value of certain content depends on its memorability, for instance, the ability of a viewer to remember aspects of the content, such as a message, instructions, a brand, or a product. Existing tools facilitate the production of highly technical and quality media, but are incapable of effectively and accurately deriving memorability information. Accordingly, developers lack sufficient technologies to understand content memorability and, therefore, to optimize the impression of visual media on viewers

### SUMMARY

Embodiments are generally directed to extending artificial intelligence (AI) and machine learning (ML) techniques to determine the memorability of visual content. More specifically, embodiments are directed to a machine-learning based approach that learns to predict the memorability of visual content, such as videos, images, and/or the like. For example, some embodiments utilize a visual encoding framework to convert visual content into language tokens that textually define various features of the visual content. In various embodiments, the language tokens include text generated through verbalization of the visual content, for instance, via optical character recognition (OCR), object detection, speech-to-text analysis, and/or the like. In some embodiments, the language tokens are determined by processing visual content embeddings generated by a series of machine-learning models trained to encode visual aspects of videos, images, and/or other visual media. The language tokens are provided to a language model (for instance, a large transformer-based model, such as a large language model (LLM)) trained to analyze language tokens of visual content to generate a memorability prediction for the visual content.

In some embodiments, a ML architecture includes a visual-language model that combines the processing of visual and textual information. The ML architecture includes one or more pre-trained visual encoders operative to understand and generate meaningful representations from visual content, for example, by generating visual encodings of the visual content. In general, a visual encoder operates to embed an image (or other visual input) into its most important parts. An example of a pre-trained visual encoder is a contrastive language-image pre-training (CLIP) made by OpenAI, Inc., among others. The visual encodings are provided as input to a vision transformer (ViT) model to convert the visual encodings into language tokens, for instance, textual representations of the visual encodings. The language tokens derived from the visual encodings are concatenated, or otherwise combined, with other language tokens, for instance, tokens derived from verbalization, user input text, and/or the like and provided to the LLM. A non-limiting example of an LLM is the LLaMA LLM provided by Meta Platforms, Inc.

In some embodiments, the LLM is trained using long-term memorability information to predict viewer long term memorability (for instance, a duration of about two days to about 4 days) of visual content based on language tokens generated from the visual content. Accordingly, the memorability prediction for visual content is a long-term memorability prediction. In various embodiments, the memorability prediction is a memorability score (for instance, on a scale of 0-100) indicating how likely a viewer will remember the visual content on a long-term memory time scale.

Any of the above embodiments may be implemented as instructions stored on a non-transitory computer-readable storage medium and/or embodied as an apparatus with a memory and a processor performs the actions described above. It is contemplated that these embodiments may be deployed individually to achieve improvements in resource requirements and library construction time. Alternatively, any of the embodiments may be used in combination with each other in order to achieve synergistic effects, some of which are noted above and elsewhere herein.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example system in accordance with embodiments described in the present disclosure.

FIG. 2 illustrates an example of a processing flow in accordance with embodiments described in the present disclosure.

FIG. 3 illustrates an example of a processing flow in accordance with embodiments described in the present disclosure.

FIG. 4 illustrates an example of a processing flow in accordance with embodiments described in the present disclosure.

FIG. 5 illustrates an example of a processing flow in accordance with embodiments described in the present disclosure.

FIG. 6 illustrates features of the subject matter in accordance with embodiments described in the present disclosure.

FIG. 7 illustrates features of the subject matter in accordance with embodiments described in the present disclosure.

FIG. 8 illustrates features of the subject matter in accordance with embodiments described in the present disclosure.

FIG. 9 illustrates features of the subject matter in accordance with embodiments described in the present disclosure.

FIG. 10 illustrates a routine in accordance with one embodiment.

FIG. 11 illustrates a routine in accordance with one embodiment.

FIG. 12 illustrates a system in accordance with one embodiment.

FIG. 13 illustrates an apparatus in accordance with one embodiment.

FIG. 14 illustrates an artificial intelligence architecture in accordance with one embodiment.

FIG. 15 illustrates an artificial neural network in accordance with one embodiment.

FIG. 16 illustrates a computer-readable storage medium in accordance with one embodiment.

FIG. 17 illustrates a computing architecture in accordance with one embodiment.

FIG. 18 illustrates a communications architecture in accordance with one embodiment.

### DETAILED DESCRIPTION

Embodiments are directed to a machine-learning based approach that uses a language model trained with memorability information to generate a memorability prediction of visual content based on language information extracted from the visual content. In some embodiments, the language model is a large transformer-based model, such as a large language model (LLM). A non-limiting example of a LLM is LLAMA provided by Meta Platforms, Inc. Various embodiments utilize a visual encoding framework to convert visual content into language information, such as language tokens, that textually define various features of the visual content. In some embodiments, the language tokens include text generated through verbalization of the visual content, for instance, via optical character recognition (OCR), object detection, speech-to-text analysis, and/or the like. In some embodiments, the language tokens are determined by processing visual content embeddings generated by a series of machine-learning models trained to encode visual aspects of videos, images, and/or other visual media. The language tokens are provided to the language model to generate a memorability prediction for the visual content.

In some embodiments, an ML architecture includes a visual-language model that combines the processing of visual and textual information. The ML architecture includes one or more pre-trained visual encoders operative to process visual information, such as videos and images. In various embodiments, the visual encoders are configured to understand and generate meaningful representations from visual content, for example, by generating visual encodings of the visual content. The visual encoders are connected or bootstrapped to a vision transformer (ViT) model that is operative to convert the visual encodings into language tokens, for instance, textual representations of the visual encodings. The language tokens derived from the visual encodings are concatenated, or otherwise combined, with other language tokens, for instance, tokens derived from verbalization, user input text (for instance, providing context for the visual content), and/or the like and provided to the LLM.

In some embodiments, the LLM is trained using long-term memorability information to predict viewer long term memorability (for instance, a duration of about one day to about 4 days) of visual content based on language tokens generated from the visual content. Accordingly, the memorability prediction for visual content is a long-term memorability prediction. In various embodiments, the memorability prediction is a memorability score (for instance, on a scale of 0-100) indicating how likely a viewer will remember the visual content on a long-term memory time scale.

Systems and methods according to the embodiments described in the present disclosure provide numerous technological advantages over existing techniques. In one non-limiting example of a technological advantage, embodiments operate to effectively and accurately model and predict the long-term memorability of digital content. Existing systems are not capable of accurately modeling content memorability and, in particular, are devoid of long-term memorability analysis. In another non-limiting example of a technological advantage, embodiments provide an AI/ML architecture is provided to simulate viewer recall of content so that content creators can receive memorability information before publishing the content to the public. Conventional techniques rely on in-person, specialized surveys, which are cost and resource intensive, and are not able to be performed in sufficient time to be of value to content creators, particularly on daily basis. In another non-limiting example of a technological advantage, the AI/ML architecture generates memorability prediction feedback that provides creators with an understanding of factors that make content memorable and, as a result, helps content creators design better media offerings. Conventional techniques are merely able to provide broad guidelines that apply generally to content, but do not provide real-time analysis particularized for each developer's designs.

As used herein, “content,” “visual content,” “media” or any variations thereof refers to any digital media, including, but not limited to, any website, any email, any graphic, any video, any image, any audio, any text, any computer program, and/or any other type of digital media and/or any combinations thereof.

As used herein, “memorability” or any variations thereof refers to the quality or measure of content being remembered by a viewer or likely to be remembered by a viewer.

As used herein, “long-term memorability” or any variations thereof refers to memorability over a long-term duration (as opposed to short-term memorability), including a duration equal to or greater than 12 hours, one day, two days, three days, four days, one week, two weeks, one month, six months, and any value or range between any two of these values (including endpoints). In some examples, a long-term duration is about one day. In some examples, a long-term duration is about two days to about four days. In some examples, a long-term duration is about one day to about five days.

As used herein, “short-term memorability” or any variations thereof refers to memorability over a short-term duration (as opposed to long-term memorability), which typically includes a duration up to a few minutes, but may include a duration equal to or less than one minute, five minutes, one hour, 12 hours, and any value or range between any two of these values (including endpoints).

As used herein, “memorability prediction” or any variations thereof refers to a quantitative value assigned to content indicating the memorability of the content, including, in some embodiments, a numerical score on a memorability scale (for instance, on a scale of a low of 0 to a high of 99).

As used herein, a “language model” refers to a deep learning AI algorithm configured to perform natural language processing (NLP) tasks using transformer models and/or neural networks (NNs) trained using massive data sets to recognize, predict, or generate text based on language input. A non-limiting example of an NLP model is a large language model (LLM), such as the LLaMA LLM provided by Meta Platforms, Inc.

As used herein, “world knowledge” or any variations thereof refers to the learned concepts of a language model resulting from model training beyond direct linguistic information of the training vocabulary (e.g., linguistic information indicates that the word “fireplace” is a place for a domestic fire located at the base of a chimney; world knowledge indicates that the term “fireplace” often connotes hospitality, warm comfort, etc.).

As used herein, “language space” or “language embeddings” refers to a textual, natural language description of content for use by a natural language processing (NLP) model, such as an LLM. For example, a digital image of a flower can be transformed to the language space of “an image of a red rose in a white vase.”

As used herein, “language tokens” refer to a basic unit of text in the language space, for example, used as input by an NLP model to generate an output.

As used herein, a “visual encoder” or “vision encoder” refers to an AI/ML model trained to generate visual embeddings that represent the content and visual features of an input image. A non-limiting example of a visual encoder is a vision transformer (ViT) model, which is a NN pre-trained on image-text pairs to generate visual embeddings based on image input. Non-limiting examples of ViTs include Contrastive Language-Image Pre-Training (CLIP) and (Explore the limits of Visual representation at scAle) EVA-CLIP.

As used herein, “verbalization” is the process of generating verbal or textual information directly from a video or image using perception tools or other various techniques including, without limitation, optical character recognition (OCR), audio and speech recognition (ASR), text-to-speech, object detection, emotion detection, color detection, aesthetics detection, and/or the like. In general, detection perception tools include tools configured to detect a feature (e.g., an object, an emotion, etc.) and to provide a textual description of the feature.

Content creators expend immense amounts of time and financial resources creating and distributing content. The value of certain content is dependent upon its memorability, particularly its long-term memorability. For example, for advertisement content, marketers are interested in viewer long-term memorability so that a consumer remembers the brand, product, and/or the like at a later time when making a purchasing decision. In another example, for educational or instructional content, a content creator is interested in a viewer remembering an educational message, instructions, and/or the like in the future for a test, performance of a task, or other activity. In a further example, for entertainment content, such as a movie, a short-form video, a social media posting, and/or the like, a content creator is interested in the long-term memorability of their work, for instance, in an effort to increase their popularity and the popularity of their content with viewers.

Although advertisement content, advertisement campaigns, and/or other advertisement-related examples are used in the present disclosure, embodiments are not so limited, as advertisement-related examples are used for illustrative purposes only. Other types of content, including, without limitation, educational content, instructional content, and entertainment content, may also be used in various embodiments described in the present disclosure.

The global content creation and delivery industry involves numerous multi-billion dollar enterprises that span several interconnected content sectors, for instance, entertainment companies, advertising companies, and social media companies. The world wide web, one of the most-used technical resources globally for both business and personal use, is mostly funded by advertising and requires the generation of vast amounts of content, including educational, instructional, and entertainment content. With the vast expenditure of time and resources on distributing advertisements and other content, it is imperative for content creators and distributers to know if any of their content (e.g., a brand, a message, and/or the like) would even be recalled at a future time, such as the viewer's purchase time or when selecting new content to watch. Knowledge of such long-term memorability would help content creators optimize their costs, content, delivery, and audience, ultimately helping in boosting sales, increasing content consumption and/or popularity, or other goals.

Accordingly, some embodiments provide a memorability prediction system configured to predict the memorability of content. The embodiments provide several advantages and benefits relative to conventional techniques, including existing AI/ML techniques. For example, content creation techniques suffer from at least the following key challenges: (1) the inability to simulate the memorability of content before it is released; (2) the absence of an AI/ML solution specifically configured for long-term memorability analysis; and (3) the inability to determine features of a specific item of content (or features that are missing or require adjustment) that directly affect the memorability of item of content.

With respect to the first challenge, embodiments implement a memorability prediction system that includes an AI/ML architecture configured to receive visual content as input and to generate a memorability prediction for the content as output. The AI/ML architecture allows a user to simulate viewer recall of content and receive memorability information before publishing the content to the public. With conventional systems, content creators were limited to relying on viewer surveys or tracking user online behavior and tying this information to future viewing or sales data. Accordingly, memorability analysis of content, particularly long-term memorability analysis, was only available via in-person research performed by specific and/or ad-hoc surveys. However, embodiments provide systems where content creators can obtain instant memorability analysis information, including for long-term memorability, of their creations, for instance, within content creation tools. In this manner, each content creator is able to be their own memorability researcher from their computing device during the content creation process.

With respect to the second challenge, the AI/ML architecture includes a language model trained on long-term content memorability training data to provide memorability predictions specifically targeted to long-term memory durations. Existing techniques relied on various short-term content memorability studies (e.g., recall within a few seconds to a few minutes) or long-term memorability research that did not relate directly to visual content recall, which does not provide for adequate training of AI/ML models for determining accurate and useful long-term memorability predictions for visual content.

With respect to the third challenge, the AI/ML architecture provides memorability prediction feedback for specific items of content, such as a prediction score, that provides creators with an understanding of factors that make content memorable (particularly over a long-term duration) for their particular item of content, and thus, helps content creators design better media offerings. Existing solutions and memorability data are merely able to provide broad guidelines that applied generally to content (e.g., the use of logos increases memorability, scene clutter decreases memorability, etc.). Using the AI/ML architecture according to some embodiments, a user receives a memorability score specialized for their particular item of content, makes changes to the content to generate a new (higher) score to increase the potential memorability of the content before distribution, and repeats until a desired memorability prediction score is reached.

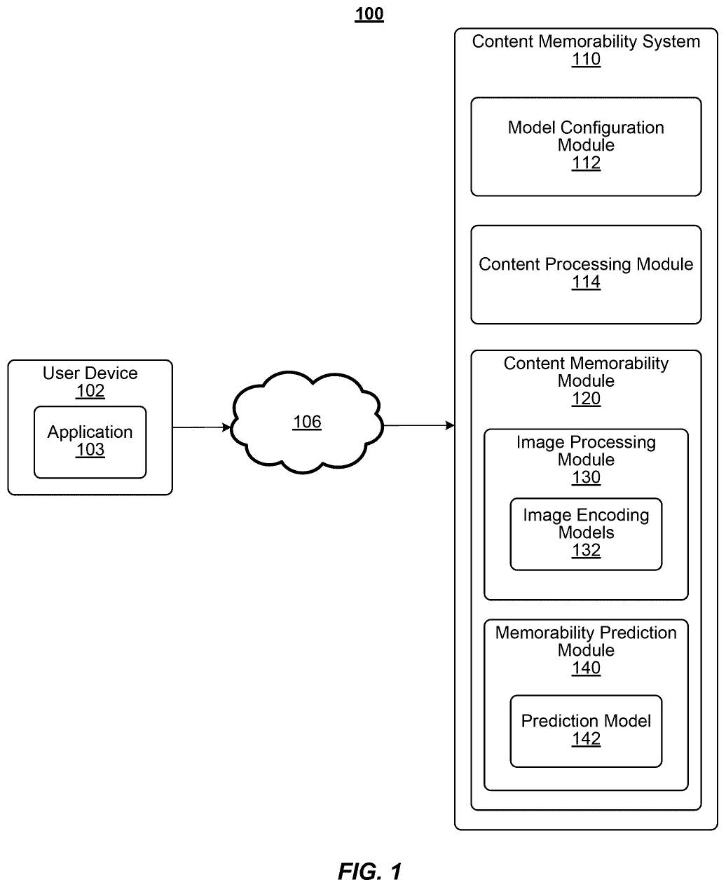

FIG. 1 illustrates an example embodiment of a system 100 that performs the operations discussed herein. The system 100 includes additional systems and computing components to perform various operations. In one example, the system 100 includes a content memorability system 110 including components or modules to perform operations for simulating the memorability of visual content. These modules include a model configuration module 112, a content processing module 114, and a content memorability module 120. Each of the modules performs one or more operations to configure, train, and/or tune at least one model, process visual content, and simulate memorability for the visual content.

In various embodiments, the content memorability system 110 implements an AI/ML based approach that learns to predict visual content memorability by leveraging visual content memorability data (in some embodiments, long-term memorability data) and language models trained with the visual content memorability data and tuned specifically to generate memorability predictions based on text derived from features of visual content.

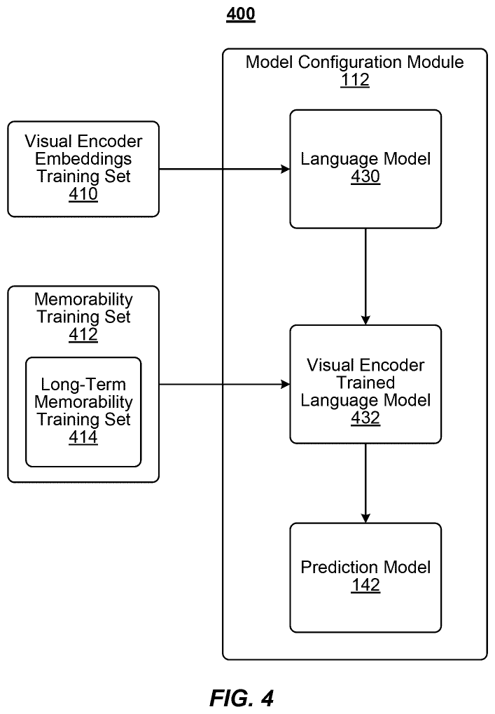

In some embodiments, the model configuration module 112 operates to configure one or more AI/ML models of the content memorability system 110. The configuration of AI/ML models includes model training, tuning, and/or the like. For example, the model configuration module 112 is configured to train a language model (for instance, an LLM) on long-term and/or short-term memorability data samples to capture world knowledge of content memorability based on visual concepts of visual content (see, for example, FIG. 4).

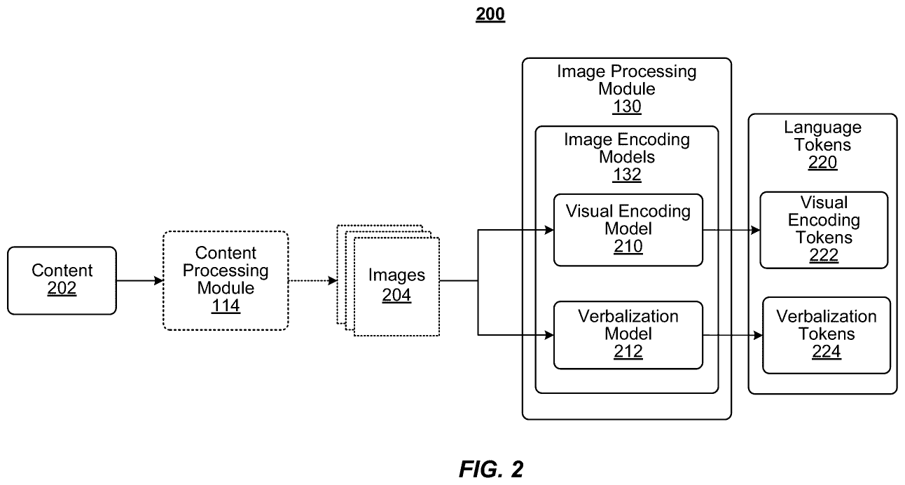

In various embodiments, the content processing module 112 operates to process visual content to make it suitable for processing, analysis, tokenization, and/or the like by components of the content memorability system 110 (see, for example, FIG. 2). For instance, the content processing module 112 preprocesses video to generate one or more single images (or frames) from the video. In another example, the content processing module 112 samples frames from a plurality of frames generated from a video, for instance, to determine important or distinguishing frames to be used as input to a visual encoder.

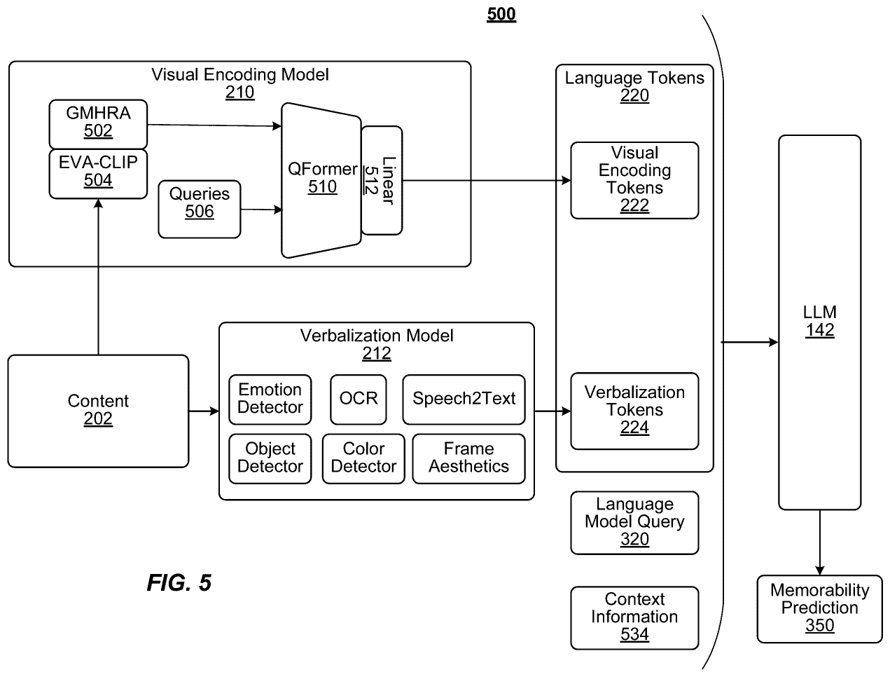

In exemplary embodiments, the content memorability module 120 operates to generate memorability information or predictions for visual content (see, for example, FIG. 5). The content memorability module 120 includes an image processing module 130 and a memorability prediction module 140.

The image processing module 130 operates to encode visual content in a form suitable as input by a prediction model 142 of the memorability prediction module 140 (see, for example, FIG. 2). In various embodiments, the image processing module 130 includes an architecture of one or more pre-trained AI/ML models configured to receive visual content (i.e., a video or image) and to generate language tokens textually indicating various aspects of the visual content. In some embodiments, the image processing module 130 includes verbalization tools operative to generate language tokens from the visual content using one or more verbalization techniques, such as OCR, ASR, text-to-speech, and/or the like. The language tokens resulting from AI/ML processing and/or verbalization are provided to the prediction model 142.

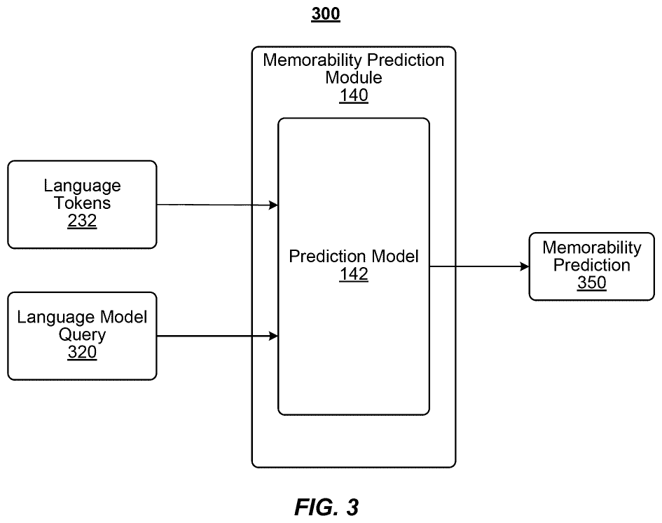

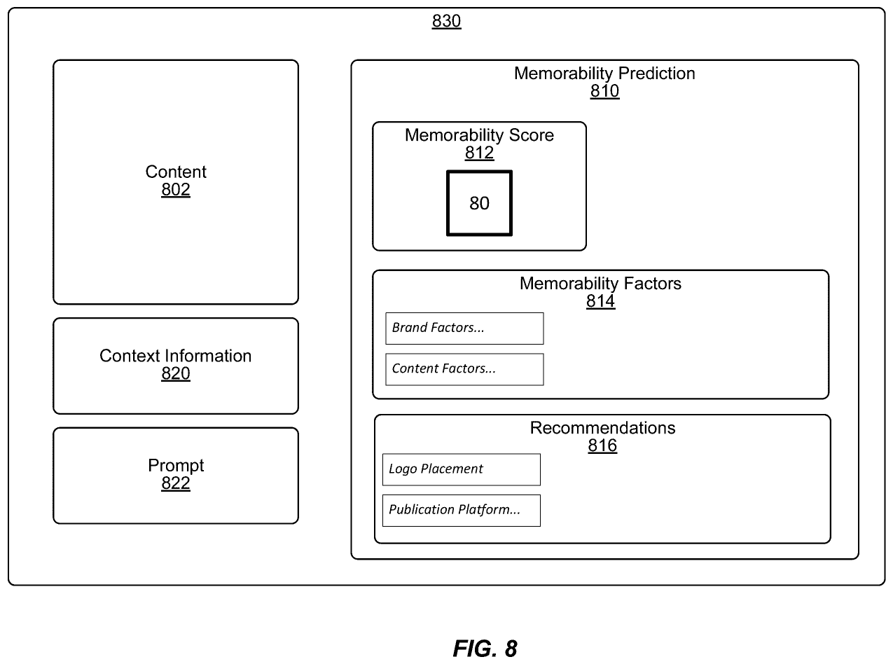

The memory prediction module 140 is configured to generate memorability information, for instance, a memorability prediction score for an item of visual content. The memory prediction module 140 includes a prediction model 142 (see, for example, FIG. 3) configured to receive textual input, including language tokens from the image processing module 130 and context information (e.g., user-provided text input providing context or other associated information for the visual content). The prediction model 142 generates memorability information associated with the visual content associated with the language tokens. In some embodiments, the memorability information includes a prediction score configured as a numerical indicator of the memorability of the visual content. In various embodiments, the memorability information includes recommendations for modifying the visual content to increase the memorability of the visual content, for instance, by adding one or more objects, changing aesthetic properties, logo or brand usage, and/or the like (see, for example, FIG. 8).

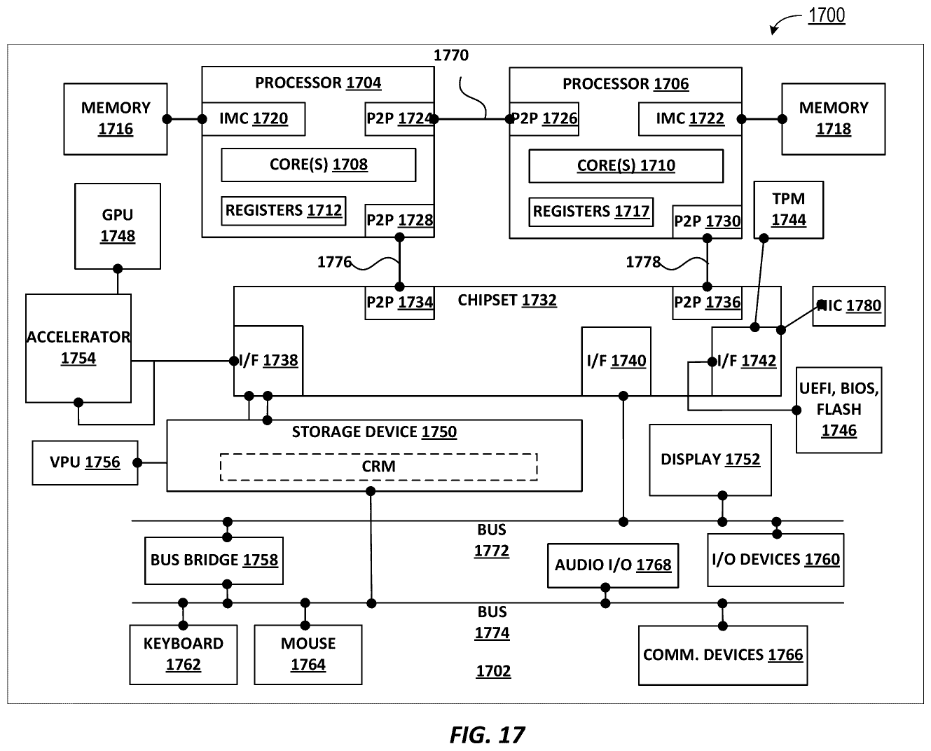

The system 100 includes a user device 102 configured to communicate with the content memorability system 110, for example, via a network 106, which may include, without limitation, one or more local area networks (LANs), wide area networks (WANs), the internet, a wired or wireless network, and/or the like. Each of the user device 102 and content memorability system 110 shown in FIG. 1 can comprise one or more computer devices, such as the computing architecture 1700 of FIG. 17. It should be understood that any number of user devices 102 and content memorability systems 110 may be employed within the system 100 within the scope of the present disclosure. Each of user device 102 and content memorability system 110 may comprise a single device or multiple devices cooperating in a distributed environment. For instance, the content memorability system 110 could be provided by multiple server devices collectively providing the functionality of the content memorability system 110 as described in the present disclosure. Additionally, other components not shown may also be included within the environment of network 106.

The user device 102 can be any type of computing device, such as, for instance, a personal computer (PC), tablet computer, desktop computer, mobile device, smartphone, tablet device, or any other suitable device having one or more processors. As shown in FIG. 1, the user device 102 includes an application 103 for interacting with the content memorability system 110. The application 103 can be, for instance, a web browser or a dedicated application for providing functions, such as those described in the present disclosure. In some embodiments, the application 103 includes some or all components of the content memorability system 110. While the content memorability system 110 is shown separate from the user device 102 in the configuration of FIG. 1, it should be understood that in other configurations, some or all of the functions of the content memorability system 110 can be provided on the user device 102. For instance, in some embodiments, the content memorability system 110 is provided entirely on the user device 102.

In some embodiments, the content memorability system 110 is or is a part or feature of a content creation, distribution, and/or publication platform. For example, a content creation application can provide a feature for determining memorability information for visual content created within the content creation application. For instance, during or after designing an item of content, a user executes a memorability analysis for the item of content from within the content creation application. Based on the memorability analysis, the user can continue to design or edit the item of content prior to distribution. In other embodiments, the content memorability system 110 is a stand alone application configured to receive visual content input generated by an external application (i.e., visual content files are uploaded to the content memorability system 110).

FIG. 2 illustrates an example of a processing flow 200 for generating language tokens from visual content in accordance with embodiments described in the present disclosure. As shown in FIG. 2, content 202 is provided to the image processing module 130. In some embodiments, the content 202 is provided via application 103. The content 202 includes any type of digital content, for example, videos, images, text, prompts, visual themes, color pallets, aesthetic information, portions thereof, and/or the like. In exemplary embodiments, the content 202 is or includes one or more digital files (e.g., *.mp3, *.mov, *.bmp, *.jpeg, etc.).

In some embodiments, the content 202 is or includes a user text prompt for use by a text-to-image generation model to create a video, image or other graphic elements from a single text prompt. For example, the content 202 could include the text prompt “female athlete running in urban environment with running shoes made by Company A while Company A logo is displayed and Song X is playing.” Prominent text-to-image systems include text-to-image diffusion models and text-to-image generative adversarial networks (GANs) that generate images and image elements from natural language prompts. In various embodiments, the content 202 is or includes high-level concepts such as color schemes (e.g., pastel, neon), locations (e.g., city, school, beach), potential individuals in the content (e.g., specific actors or athletes, general types, such as a parent, doctor, teacher, etc.), and/or the like. In some embodiments, the content 202 is a video or image. In other embodiments, the content 202 is a series of content, such as an advertising campaign, lecture series, instruction series, and/or the like intended to be analyzed as a collection (in some embodiments, a collection with a specific order).

In some embodiments, the content 202 is processed via content processing module 114. For instance, certain image encoding models 132 require input to be in a certain form for processing. In one example, an image encoding models 132 requires input with specific image formatting, in a certain file type, and/or the like. In another example, certain visual encoding models 210 or verbalization models 212 can only process single images. In a further example, the processing of an entire video can require too much time or processing resources. In addition, not all of the frames of a video are important in determining memorability (for example, certain frames are essentially duplicates or are otherwise redundant). Accordingly, the content processing module 114 can transform content 202 into a certain format and/or parse video content 202 into single frames or images 204 prior to being input to the visual encoding model 210.

The content processing module 114 generates one or more single images 204 from video content 202 through a frame sampling process configured to sample the most important frames from a video. In some embodiments, a sampling technique based on cinematography principles that involves converting frames into a color space, such as the HSV color space (hue, saturation, value), although other color spaces can also be used. The sampling technique detects scene changes by analyzing changes in HSV intensity and/or edges in the scene, for example, based on a threshold. In one non-limiting example, the threshold is about 0.3, for instance, from the “30-degree rule” associated with standard jump-cut avoidance principles. In general, the 30-degree rule can be formulated as follows: after a “cut” (camera stops and re-starts shooting), the camera angle must change by at least 30 degrees. For dominant frame selection, common blur/sharpness heuristics fail in the presence of text in image; therefore, the sampling technique extracts the frame with the least changes. The 30-degree rule and jump-cut avoidance are for illustrative purposes as the sampling technique is operative with other frame sampling methods.

The content 202, for example, in the form of images (or frames) 204 is input into one or both of the visual encoding model 210 and the verbalization model 212. The visual encoding model 210 includes an architecture of AI/ML models that collectively operate to provide vision-language analysis of visual content (see, for example, detail of visual encoding model 210 in FIG. 5). Certain of the AI/ML models of visual encoding model 210 are pre-trained to encode images into visual embedding and other AI/ML models are pre-trained to transform these visual embeddings into language or text (for instance, that can be used or more optimally used by a language mode, such as prediction model 142).

In some embodiments, images 204 are input into a pre-trained visual encoder or visual transformer (ViT) of the visual encoding model 210. A ViT operates to generate visual embeddings that capture the spatial interactions in an image frame. A non-limiting example of a visual encoder is a contrastive language-image pre-training (CLIP). In some embodiments, CLIP is configured as an (Explore the limits of Visual representation at scAle) EVA-CLIP model. In general, a CLIP model is a large-scale, pre-trained deep learning model that learns from image-text pairs. It leverages a contrastive learning approach to simultaneously learn to generate image and text embeddings in a shared latent space. The model is trained on a diverse set of internet images and their associated textual descriptions. This pre-training process enables the CLIP model to learn a wide range of visual and textual concepts, which is fine-tuned for various downstream tasks. In general, EVA-CLIP uses pre-trained EVA models that combines high-level semantics of image-text contrastive learning with geometric and structural capture from masked image modeling. In some examples, EVA-CLIP is configured to use pre-trained EVA weights to initialize the image encoder of EVA-CLIP.

In various embodiments, the visual encoder is incorporated with an aggregator, such as a multi-head relation aggregator (MHRA) or global MHRA (GMHRA). The aggregator operates as a temporal modeling module. The output of the visual encoder is aggregated by GMHRA, for example, to provide improved information across the time dimension of the content 202.

The visual embeddings output of the visual encoder is input into a querying transformer configured to map the visual space represented by the visual embeddings into a language space, for example, that can be used by a language model (e.g., prediction model 142). A non-limiting example of a querying transformer is QFormer. In some embodiments, QFormer is configured the same or substantially similar to the configuration in the he BLIP-2 vision language model developed by Salesforce AI Research. QFormer operates to convert visual embeddings (or tokens) generated by a visual encoder into language embeddings (or tokens), for example, suitable for use or more optimal for use by an LLM language model. QFormer has been pre-trained to extract language-informative visual representation that feeds the most useful information to the LLM while removing irrelevant visual information.

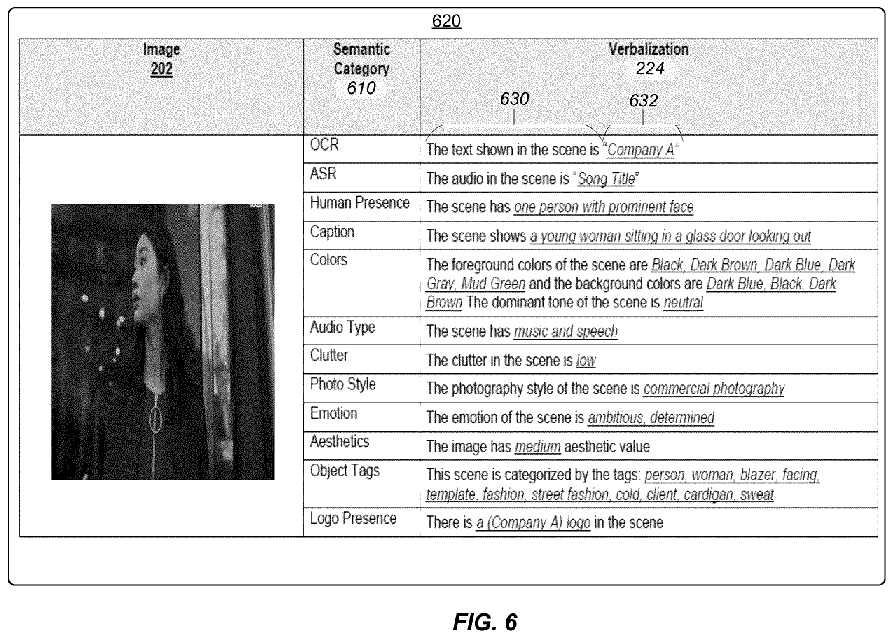

Referring to FIG. 2, output of the visual encoding model 210 includes language tokens 220, for example, visual encoding tokens 222 resulting from encoding images 204 from the visual space (e.g., via a ViT, such as EVA-CLIP/GMHRA) to the language space (e.g., via a querying transformer, such as QFormer). In some embodiments, visual encoding tokens 222 include concise, detailed, natural language descriptions of the substance of the content 202 (or the images 204 of the content 202). For example, for the example content 202 image shown in FIG. 6, the visual encoding tokens 222 in the language space include “we see a young woman with long dark hair, wearing dark athletic clothing, within an urban landscape at night time; she is looking intensely off to the side.” For video content, in some embodiments, the visual encoding tokens 222 includes a scene-by-scene description. For instance, “In a first scene, <description of scene 1>. Next, <description of scene 2>. Next, <description of scene 3>” and so on.

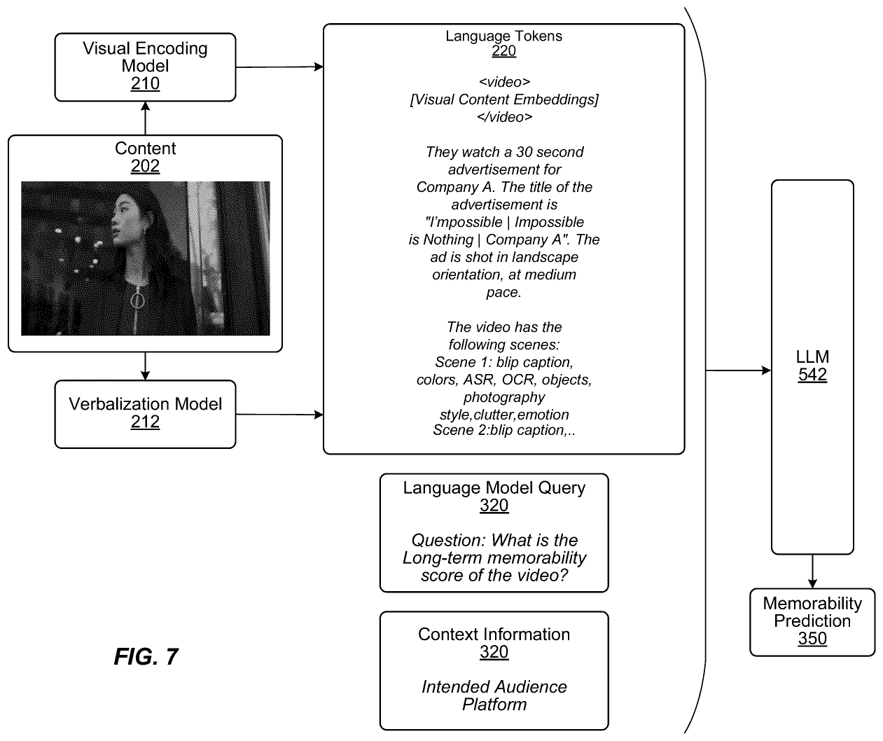

As shown in FIG. 2, the content 202 (for instance, in the form of images 204) is provided as input to the verbalization model 212. In some embodiments, the verbalization model 212 includes one or more verbalization processes configured to extract textual information from images 204. In various embodiments, the verbalization model 212 includes one or more perception tools configured to verbalize image semantic information. Non-limiting examples of perception tools include image caption, image textual metadata, platform information (e.g., the image is/will be published via YouTube®, with the following title and caption), visual tags, orientation, OCR, ASR, text-to-speech, object detection, emotion detection, color detection, aesthetics detection, and/or the like. For example, images 204 are processed via OCR to recognize any text in the input images 204. In another example, an ASR process operates to process sounds associated with the content 202 and to translate any detected words, etc. into text. In a further example, an object detection process operates to detect objects in an image and to provide text describing the objects (e.g., a blue car, a gray building, etc.). The verbalization model 212 generates language tokens 220, for instance, in the form of verbalization tokens 224 that represent scene descriptors in the images 204 that can be verbalized in text form (see, for example, FIG. 7).

In some embodiments, the language tokens 220 include a language space formed from concatenating or otherwise combining the visual encoding tokens 222 and the verbalization tokens 224. In some embodiments, the verbalization tokens 224 operate to ground the visual encoding tokens 222 in the language space of the prediction model 142.

FIG. 3 illustrates an example of a processing flow 300 for determining a memorability prediction in accordance with embodiments described in the present disclosure. As shown in FIG. 3, the language tokens 220 are input into the prediction model 142 of the memorability prediction module 140. In some embodiments, the prediction model 142 is trained on memorability data (see, for example, FIG. 4) to generate the memorability prediction 350 for a specific item of content 202 based on the language tokens 220 developed from the content 202.

In this manner, embodiments are configured to connect the vision knowledge of a visual encoder (e.g., EVA-CLIP) with the world knowledge of an LLM or other language model. The visual encoder helps the model to “see” the visual content. The visual encoder embeddings from the visual encoder are converted to the language space using a transformer, for instance, QFormer, and are further augment with scene “verbalization,” for instance, involving scene descriptors like visual caption, optical character recognition (OCR), automatic speech recognition (ASR), emotion, color distribution, and scene complexity scores, which help ground the visual knowledge in the LLM's world knowledge.

Accordingly, some embodiments operate to map visual signals (e.g., visual encoder output and verbalizations) to language semantics (e.g., language tokens 220), allowing for the leveraging of visual knowledge from visual embedding models (e.g., ViT) and world knowledge from LLMs. The world knowledge facilitates LLM understanding of the semantics of the content 202 (as described via the language tokens 220) in relation to visual concepts from the content 202. For instance, the world knowledge allows the LLM to understand the semantics of an advertisement, brand knowledge, and/or the like and to consolidate this understanding with the visual semantics from the advertisement content. In one example, the prediction model 142 interprets an Airbnb advertisement that shows an adult female and a male with the text, “Our guest room is paying for our wedding,” to relate to a couple saying that renting out their space on Airbnb (i.e., an online marketplace for property rentals) helps the couple sponsor their wedding. World knowledge captured in LLMs, together with the visual knowledge of ViT, helps to identify the two adults as a couple and to relate the text with the Airbnb logo and make sense of all three concepts together.

In various embodiments, a language model query 320 is input into the prediction model 142 to provide a prompt for the prediction model 142 to generate output. The type and format of the language model query 320 is based on the nature of the training of the prediction model 142. In some embodiments, the prediction model 142 is trained to analyze the memorability (short-term and/or long-term) of content 202. Accordingly, in one example, the language model query 320 is the question “What is the memorability score of the content?” In one example for a long-term memorability analysis, the language model query 320 is the question “What is the long-term memorability score of the content?”

In some embodiments, the memorability prediction 350 includes information associated with the memorability of the content 202 associated with the language tokens 220. In one example, the memorability prediction 350 is a value or score indicating the memorability of the content 202. The range and/or type of values of a memorability prediction 350 score is dependent on the specific training of the prediction model 142. In one example, the memorability prediction 350 score is a value from 0 to 100 (or 99) indicating a percentage of viewers predicted to remember the content 202 over a long-term duration (e.g., one day to four days). In another example, the memorability prediction 350 score is a value from 0.0 to 1.0 indicating the long-term memorability of the content 202 in relation to a standard content or a standard content corpus (for example, advertisements, instructional videos, and/or the like with known real-world long-term memorability scores).

In some embodiments, the memorability prediction 350 includes content recommendations, for instance, modifications, additions, and/or the like that would impact the memorability prediction 350 value. In one example, the memorability prediction 350 includes a score (e.g., of 50 out of 100) and a recommendation to reduce scene clutter and to add a known actor to increase the memorability prediction 350 value of an advertisement. In another example, the memorability prediction 350 includes a score (e.g., 40 out of 100) and a recommendation to change the background color and font of text in an instructional video. In various embodiments, the memorability prediction 350 includes memorability factors that materially affected the memorability prediction 350 value. In some embodiments, the memorability factors are associated with score weights, for instance, indicating their impact on the memorability prediction 350 score. In one example, the memorability prediction 350 includes a score (e.g., 50 out of 100) and a memorability factor of logo placement with a score weight of −5, indicating that the logo placement in the content 202 decreased the score by 5 units.

In some embodiments, the prediction model 142 is trained to determine the memorability factors and/or recommendations by simulating memorability for different versions of the content 202 (even if the versions are not input directly into the prediction model 142). In one example, the content 202 includes an image of a man wearing athletic clothing. The prediction model 142 can be trained to change the content 202, for instance, via changing the language tokens 220 and/or the content 202 (or images 204 generated from the content), and run the memorability analysis on the original content as well as alternative versions, such as with/without a logo, slogan, or other text/symbols, different colors, alternative aesthetics, and/or the like. For example, if an alternative version of the content 202 results in an increased (or decreased) memorability score (for instance, above/below a score change threshold), the prediction model 142 can indicate the changed feature (e.g., addition of a logo) as a memorability factor (and can also provide a corresponding recommendation). For instance, if changing the font from type A to type B of an instructional image increases the memorability score by 10, the prediction model 142 concludes that the font is a memorability factor and can determine a recommendation to change the font for the content 202 from type A to type B.

FIG. 4 illustrates an example of a processing flow 400 for training the prediction model 142 in accordance with embodiments described in the present disclosure. In some embodiments, the prediction model 142 is trained via the model configuration module 112 in a two-stage AI/ML model training process. The first stage operates to align the visual encoder embeddings (e.g., language tokens) with the language model via a large-scale pretraining approach to learn to process content visual information transformed into the language space. In the second stage, the language model is trained with large-scale, high-quality memorability information to learn to predict memorability based on the visual information (and any other context information provided to the language mode).

As shown in FIG. 4, a language model 430 is accessed for training. The language model 430 includes a deep-learning NLP model, such as a transformer-based model. In some embodiments, the language model 430 is or includes an LLM. Although an LLM, and LLAMA specifically, have been used in some examples, embodiments are not so limited as the language model 430 may be or may include other models, including, without limitation, bidirectional encoder representations from transformers (BERT), a language representation model (LRM), neural network-based language prediction models, a generative pre-trained transformer (GPT) model (e.g., GPT-3 or GPT-4), variations thereof, combinations thereof, and/or the like. In some embodiments, the language model 430 is pre-trained prior to the first stage of training. For instance, prior to training according to some embodiments, an LLM can be pre-trained to receive a sequence of words as an input and to predict a next word, for example, to recursively generate text.

In the first stage, a visual encoder embeddings training set 410 is used to train the language model 430. In some embodiments, the visual encoder embeddings training set 410 includes datasets of visual encoder embeddings, for instance, the Webvid, COCO caption, Visual Genome, CC3M, CC12M, variations thereof, combinations thereof, and/or the like datasets. The first stage generates a visual encoder trained language model 432 trained to process visual information transformed into the language space (e.g., language token input).

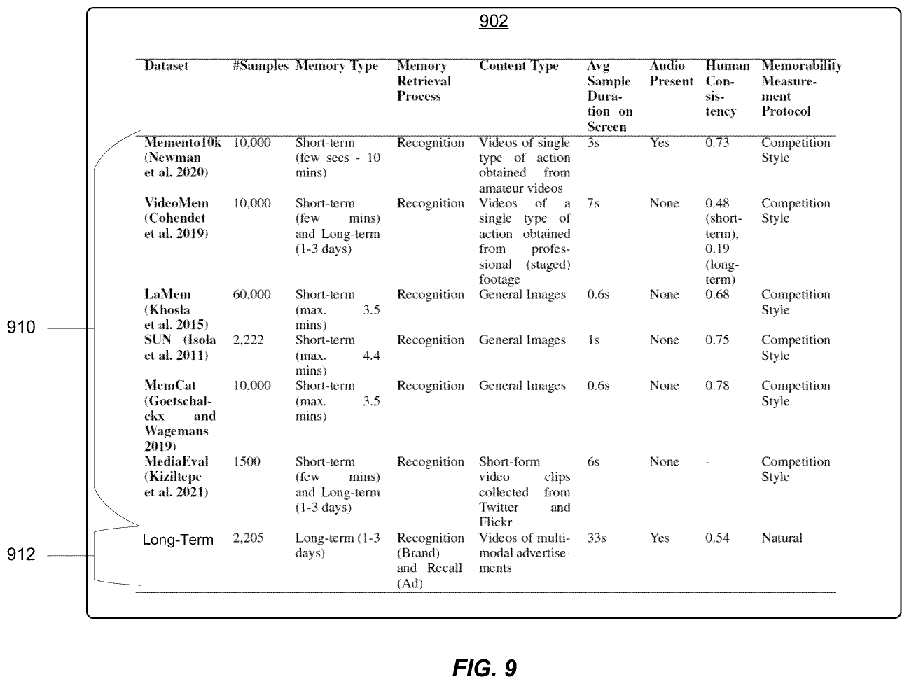

In the second stage, the visual encoder trained language model 432 is trained using one or more memorability training sets 412. In general, a memorability training set 412 includes data associated with a content memorability study analyzing viewer recall of content. In various embodiments, the memorability training sets 412 include one or more specific long-term memorability training sets 414. FIG. 9 depicts a table 902 of example memorability training sets 412, including short-term memory data sets 910 and a long-term memory data set 912.

Despite the importance of long-term memorability for content creators, existing solutions do not provide AI/ML models trained on long-term memorability data. Most studies have been conducted on short-term recall (i.e., less than about 5 mins) on specific content types like object and action videos. Accordingly, in some embodiments, one or more long-term memorability training sets 414 are used to train the prediction model 142 to produce a language model specifically configured to analyze long-term memorability of visual content. For example, the long-term memorability data set 910 includes data generated from a long-term memorability study of about 1200 participants and about 2200 visual content advertisements covering about 280 brands. Running statistical tests over different participant subpopulations and content types, insights into long term content memorability are determined indicating what makes content memorable based both on content and human factors. For example, statistical analysis of the long-term memorability data set 910 indicates that brands which use commercials with fast moving scenes are more memorable than those with slower scenes and people who use ad-blockers remember lower number of ads than those who don't.

Digital content, including advertisements, are highly multimodal; they contain video, speech, music, text overlaid on scenes, jingles, specific brand colors, etc. However, existing data sets do not include these elements (see, for example, the VideoMem, Memento10k, LaMem, etc. data sets in table 902). While memorability studies, for example, the short term data sets 910, have contributed much towards understanding the factors that drive customer memory, they are limited in their scope. In general, these experiments evaluate the effect of a single content factor while controlling for others. Further, these experiments are conducted on a limited number of advertisements and, thus, are unsuitable for training AI/ML models, particularly for long-term memory simulation. While there have been attempts to train AI/ML models to analyze short-term memory, there has been a lack of sufficient large-scale datasets and, in particular, no AI/ML models trained to simulate long-term memorability.

Accordingly, some embodiments use large-scale, comprehensive long-term memorability data sets, such as data set 912. In general, the long-term memorability data set involved 1203 participants across three sessions conducted in two institutes. Long-term memorability scores were collected for over 2205 advertisements from 276 brands, covering 113 industries. The content of the data set 912 included advertisement videos from multimodal advertisements released on YouTube® channels, with an average duration of 33 seconds. The advertisement videos included a variety of characteristics, including different scene velocities, human presence and animations, visual and audio branding, a variety of emotions, visual and scene complexity, different audio types, and/or the like.

At the outset of the study for the data set 912, participants are given a preliminary questionnaire aimed at establishing their brand-related interactions and media consumption habits (e.g., brand recall, brand usage, platform (YouTube® and/or the like) subscriptions, use of ad-blocking software, time spent on platforms, preferred content consumption devices and channels, etc.). The study targeted the various reasons why content, such as an advertisement, might be memorable, including brand factors (e.g., brand popularity, industry), content factors (e.g., video emotion, scene velocity, length, speech to silence ratio), customer-content interaction factors (e.g., time of seeing the video, order in which the video was seen, time difference between watching the video and recalling the brand), and customer behavior factors (e.g., average relevance of the brand as measured by average participant ratings, video popularity, for instance as measured by platform “likes” or other similar interactions).

On day one of the study, participants saw advertisements, and after a lag time of one to five days, participants answered questions testing their brand recall, advertisement recall and recognition, scene recall and recognition, and audio recall. Next, the brand recall scores were averaged across participants and the average long-term advertisement memorability scores were computed. The long-term memorability data set 912 allows for the scores, and associated information, to be used to train AI/ML models (for instance, the prediction model 142) to predict long-term ad memorability.

In some embodiments, the memorability training sets 412 include audience-specific data based on various factors (e.g., demographic information, income level, content access platform, and/or the like). Accordingly, model training using the memorability training sets 412, including the long-term memorability data set 910, trains the prediction model 142 to operate an audience-specific memorability analysis in which content is analyzed for different audiences. For example, analysis of input content 202 can be specified for a particular audience, such as an age range (e.g., males 26-35 years of age), platform (e.g., YouTube®, Wall Street Journal® website, etc.), and/or the like. The prediction model 142 can provide different memorability predictions 350 targeted for a specific audience.

In some embodiments, the memorability training set 412 includes experimental information indicating properties of the study that is the source of real-world training data. For example, verbalizing experimental conditions facilitates providing context to the LLM about the task, which improves the accuracy of trained language models. Non-limiting examples of task type (e.g., long-term, short-term), data distribution (e.g., video advertisements, images of natural scenes), subject descriptions (e.g.: college students from College A, members of the general public of age X-Y with a male/female ratio of T, female-only participant group, etc.) are provided to the language model during one or more of the training stages. The experimental information assists in providing more comprehensive and realistic training data and solves certain training issues, such as limiting language model confusion with repeat samples (e.g., by providing an experimental context to understand the reason for the repeat samples).

Training of the visual encoder trained language model 432 with the memorability training set 412 generates the fully trained prediction model 142 operative to simulate viewer memorability of content, including, in some embodiments, long-term memorability, and to generate a memorability prediction 350. For example, the prediction model 142 takes the concatenated inputs, representing the contextual information, and is trained to predict the memorability score of the given image or video within a range (for instance, of 00 to 99). In some embodiments, during training, the prediction model 142 predicts from the complete vocabulary, while during inference, a softmax function is used over numeric tokens only to obtain a number. In various embodiments, the prediction model 142 is continuously trained using updated training data, including feedback or other training data generated based on use of the content memorability system 110 by users.

FIG. 5 illustrates an example of a processing flow 500 for determining a memorability prediction for content in accordance with embodiments described in the present disclosure. As shown in FIG. 5, content 202 is input into a visual encoding model 210 and a verbalization model 212. In some embodiments, the content 202 is processed, for instance, video content can be processed via frame sampling and/or the like to provide the content 202 as one or more images or frames.

In some embodiments, the visual encoding model 210 includes one or more vision encoders configured to generate image or visual embeddings. In some embodiments, the vision encoder is EVA-CLIP 504. CLIP model image embeddings are an n-dimensional vector (e.g., n=512) that represents the content and visual features of the input image. In general, EVA-CLIP 504 output includes visual tokens (not projected to a language space, which is performed by QFormer 510). In various embodiments, the output of EVA-CLIP 504 is provided to a GMHRA model 502 for global aggregation of visual features. The visual embeddings or knowledge from the GMHRA model 502 are input into QFormer 510 along with queries 506 of the pre-trained QFormer 510. In general, QFormer 510 is a model configured to bridge computer vision (i.e., visual encoders such as EVA-CLIP 504) and natural language models (e.g., NLP models, such as LLM 142). In general, QFormer 510 uses both the queries 506 (e.g., a prompt) and the visual tokens from the vision encoder (i.e., EVA-CLIP 504 visual tokens, for instance, as processed via GMHRA 502) to construct the input (i.e., visual encoding tokens 222) to the LLM 142. In various embodiments, the queries 506 are configured during pre-training and are designed to produce output from vision token input that is optimal for use by a language model (e.g., “describe the video or image with a rich, descriptive narrative, capturing its atmosphere and events.”). In some embodiments, QFormer 510 is associated with a linear layer 512 to facilitate the conversion from visual tokens to language tokens 220. The output of the visual encoding model 410 is a set of visual encoding tokens 222 expressing the substance of the content 202 in a language space usable by a language model, such as the predication model 142.

The content 202 is also provided to a verbalization model to generate verbalization tokens 224. FIG. 6 illustrates an example of verbalization tokens in accordance with embodiments described in the present disclosure. As shown in FIG. 6, verbalization tokens 612 are generated for multiple semantic categories 610 associated with visual perception tools, including, for example, OCR, ASR, human presence, caption, colors, and/or the like. The verbalization tokens 612 include a static verbalization template 630 (e.g., non-underlined and non-italic text) and verbalization model outputs 632 (e.g., underlined and italic text).

Accordingly, some embodiments provide processes for predicting memorability by encoding visual concepts captured through a visual encoder (ViT) (e.g., EVA-CLIP) and world knowledge captured through an LLM (e.g., LLAMA). To leverage the rich knowledge of LLMs, embodiments employ GMHRA and QFormer to convert visual tokens of the ViT to language tokens which LLaMA can understand. In addition, embodiments verbalize the visual content to facilitate the use of information describing the content more explicitly than what is provided by EVA-CLIP and QFormer. In various embodiments, the combined visual encoding models are fine-tuned with the LLM, for instance, forming a combined model, to predict user memorability.

In some embodiments, certain models of the visual encoding model 210 are “frozen” such that their parameters are not modified or tuned during use. For example, EVA-CLIP 504 and QFormer 510 are frozen.

The language tokens 220, the language model query 320, and any context information 534 are provided as input to the LLM 142. FIG. 7 illustrates example language model input in accordance with embodiments described in the present disclosure. As shown in FIG. 7, in some embodiments, the verbalization tokens 224 are concatenated or otherwise combined with the visual encoding tokens 222 to form a set of language tokens 220.

In various embodiments, the language model query 320 is configured to prompt the LLM 142 to generate one or more forms of the memorability prediction 350. In one example, the language model query 320 includes the question “What is the long-term memorability score of the video?” to prompt the LLM 142 to generate a memorability score for the language tokens 220. In another example, the language model query 320 includes the question “What changes to the content will increase the memorability score?” to prompt the LLM 142 to generate recommendations for increasing a memorability score. In a further example, the language model query 320 includes the question “What influence did the different features of the content have on the memorability of the content?” to prompt the LLM 142 to weigh or otherwise delineate different features of the content and their relation to a memorability score or other memorability evaluation.

In some embodiments, the context information 534 provides context for the LLM 142 to evaluate the language tokens 220 for making the memorability prediction 350. In various embodiments, the context information 534 includes information that can influence the memorability prediction 350. Non-limiting examples of context information 534 include an intended audience, publication platform (e.g., YouTube® versus Instagram®, ESPN® website versus Wall Street Journal® website, etc.), use of a celebrity, athlete, etc. (e.g., the text content may include a non-celebrity person, the context information 534 can request memorability if a celebrity is used in their place), and/or the like. In various embodiments, the context information 534 can be included as part of a language model query 320 (e.g., “What is the long-term memorability score of the video on YouTube® versus the ESPN® website?”).

FIG. 8 illustrates features of the subject matter in accordance with embodiments described in the present disclosure. More specifically, FIG. 8 depicts a graphical user interface (GUI) 830 for a user to interact with the content memorability system 110 to generate a memorability prediction for content. In some embodiments, the GUI 830 is implemented via application 103 accessed by a user through user device 102.

As shown in FIG. 8, a user can upload or otherwise provide content 802. For example, a user can upload an image, a video, an entire advertising (e.g., multiple advertising videos and/or images to be evaluated together), instructional series (e.g., multiple instructional videos, documents, and/or the like to be evaluated as a set), and/or the like. In various embodiments, the user has the ability to enter context information 820 associated with the content 202. In some embodiments, the user has the ability to select or enter a prompt 822, such as a specific memorability query for the content. In one example, a default prompt 822 includes a GUI object for specifying one or more various memorability predictions 810 for the content 202, such as a memorability score 812, memorability factors 814, and/or recommendations 816. In another example, a prompt 822 includes requesting long-term versus short term memorability. In a further example, a prompt 822 includes requesting a memorability score for different factors, such as publication platform, audience, and/or the like.

Responsive to uploading content 802 and selecting the prompt 822, the GUI 830 displays various memorability prediction information, including the memorability score 812, memorability factors 814, and/or recommendations 816.

Operations for the disclosed embodiments are further described with reference to the following figures. Some of the figures include a logic flow. Although such figures presented herein include a particular logic flow, the logic flow merely provides an example of how the general functionality as described herein is implemented. Further, a given logic flow does not necessarily have to be executed in the order presented unless otherwise indicated. Moreover, not all acts illustrated in a logic flow are required in some embodiments. In addition, the given logic flow is implemented by a hardware element, a software element executed by one or more processing devices, or any combination thereof. The embodiments are not limited in this context.

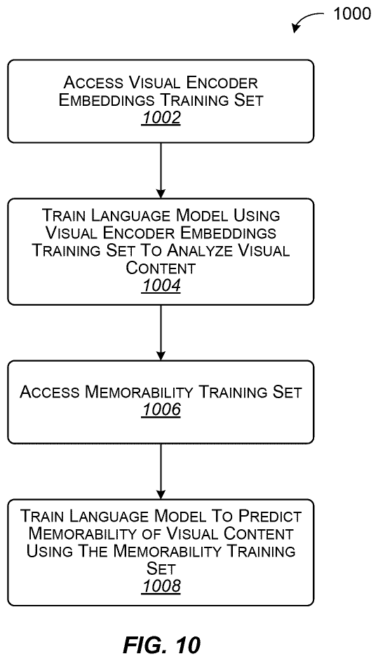

FIG. 10 illustrates an embodiment of a logic flow 1000. The logic flow 1000 is representative of some or all of the operations executed by one or more embodiments described herein, for example, for training a NLP language model to predict memorability for visual content. For example, the logic flow 1000 includes some or all of the operations performed by devices or entities within the system 100, system 1200 or the apparatus 1300. In one embodiment, the logic flow 1000 is implemented as instructions stored on a non-transitory computer-readable storage medium, such as the storage medium 1222, that when executed by the processing circuitry 1218 causes the processing circuitry 1218 to perform the described operations. The storage medium 1222 and processing circuitry 1218 may be co-located, or the instructions may be stored remotely from the processing circuitry 1218. Collectively, the storage medium 1222 and the processing circuitry 1218 may form a system.

In block 1002, the logic flow 1000 includes accessing a visual encoder embeddings training set. For instance, a visual encoder embeddings training set includes data sets configured to train a language model to process visual information. In some examples, the visual encoder embeddings training set 410 includes datasets of visual encoder embeddings, for instance, the Webvid, COCO caption, Visual Genome, CC3M, CC12M, variations thereof, combinations thereof, and/or the like datasets.

The logic flow 1000 trains a language model using the visual encoder embeddings training set to analyze visual content at block 1004. For instance, in a first training stage of the prediction model 142, visual encoder embeddings training set 410 is used to train a pre-trained language model 430, such as a pre-trained LLM. The first stage generates a visual encoder trained language model 432 trained to process visual information transformed into the language space (e.g., language token input).

At block 1006, the logic flow 1000 accesses a memorability training set. For instance, a memorability training set includes a data set of study data (including real-world data and/or simulated data) of viewer memorability of visual content. In one example, a memorability training set 412 includes data associated with a content memorability study analyzing viewer recall of content. In various embodiments, the memorability training sets 412 include one or more specific long-term memorability training sets 414 (see, for example, data set 912 of FIG. 9). In some embodiments, the memorability training set 412 includes experimental information indicating properties of the study that is the source of real-world training data. For example, verbalizing experimental conditions facilitates providing context to the LLM about the task, which improves the accuracy of trained language models.

The logic flow 1000 trains the language model to predict memorability of visual content using the memorability training set at block 1008. For example, training of the visual encoder trained language model 432 with the memorability training set 412 generates a fully trained prediction model 142 operative to simulate viewer memory of content, including, in some embodiments, long-term memorability, and to generate a memorability prediction 350.

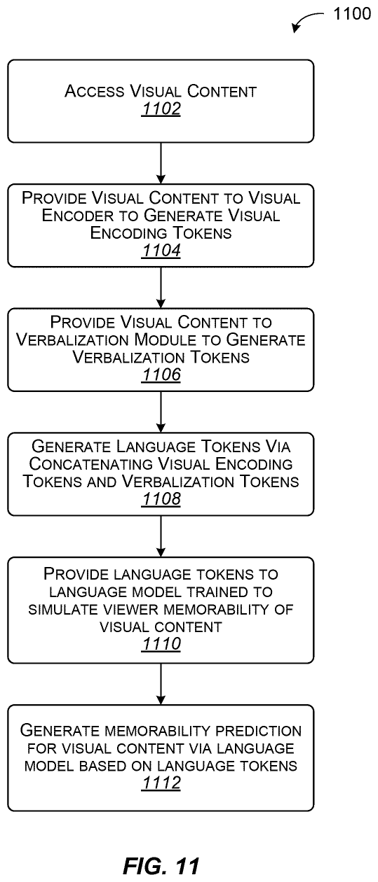

FIG. 11 illustrates an embodiment of a logic flow 1100. The logic flow 1100 is representative of some or all of the operations executed by one or more embodiments described herein, for example, for simulating the memorability of an item of visual content using a trained language model. For example, the logic flow 1100 includes some or all of the operations performed by devices or entities within the system 110, system 1200 or the apparatus 1300. In one embodiment, the logic flow 1100 is implemented as instructions stored on a non-transitory computer-readable storage medium, such as the storage medium 1222, that when executed by the processing circuitry 1218 causes the processing circuitry 1218 to perform the described operations.

At block 1102, the logic flow 1100 accesses visual content. For example, a user uploads visual content 202 via a GUI 830 providing an interface for interaction with the content memorability system 110. In some embodiments, the content 202 includes any type of digital content, which may include videos, images, text, prompts, visual themes, color pallets, aesthetic information, portions thereof, and/or the like.

The logic flow 1100 provides the visual content to a visual encoder to generate visual encoding tokens at block 1104. For example, the content 202 is provided to the visual encoding model 210 which includes one or more vision encoders (e.g., CLIP or EVA-CLIP, alone or in combination with an aggregator, such as GMHRA) configured to generate image or visual embeddings. The visual embeddings output of the visual encoder is input into a querying transformer configured to map the visual space represented by the visual embeddings into a language space, for example, that can be used by a language model (e.g., prediction model 142). A non-limiting example of a querying transformer is QFormer. The output of the visual encoding model 210 includes language tokens 220, for example, visual encoding tokens 222 resulting from encoding the content 202.

At block 1106, the logic flow 1100 provides the visual content to a verbalization module to generate verbalization tokens. For example, content 202 (for instance, in the from of images 204) is provided as input to a verbalization model 212. In various embodiments, the verbalization model 212 includes one or more perception tools (e.g., OCR, object detection, etc.) configured to verbalize image semantic information. The verbalization model 212 generates language tokens 220, for instance, in the form of verbalization tokens 224 that represent scene descriptors in the images 204 that can be verbalized in text form.

The logic flow 1100 generates language tokens via concatenating the visual encoding tokens and the verbalization tokens at block 1108. For example, language tokens 220 include a language space formed from concatenating or otherwise combining the visual encoding tokens 222 and the verbalization tokens 224.

At block 1110, the logic flow 1100 provides the language tokens to a language model trained to simulate viewer memorability of visual content. For example, the language tokens 220 are input into the prediction model 142 of the memorability prediction module 140.

The logic flow 1100 generates a memorability prediction for the visual content via the language model based on the language tokens at block 1112. For example, the language tokens 220, the language model query 320, and any context information 534 are provided as input to the LLM 142. Embodiments are configured to connect the vision knowledge of a visual encoder (e.g., EVA-CLIP) with the world knowledge of an LLM or other language model. Accordingly, the LLM 142 is configured to generate a memorability prediction 350 that includes information associated with the memorability of the content 202 associated with the language tokens 220. In one example, the memorability prediction 350 is a value or score indicating the memorability of the content 202. In another example, the memorability prediction 350 includes memorability factors that materially affected the memorability prediction 350 value. In a further example, the memorability prediction 350 includes content recommendations, for instance, modifications, additions, and/or the like that would impact the memorability prediction 350 value.

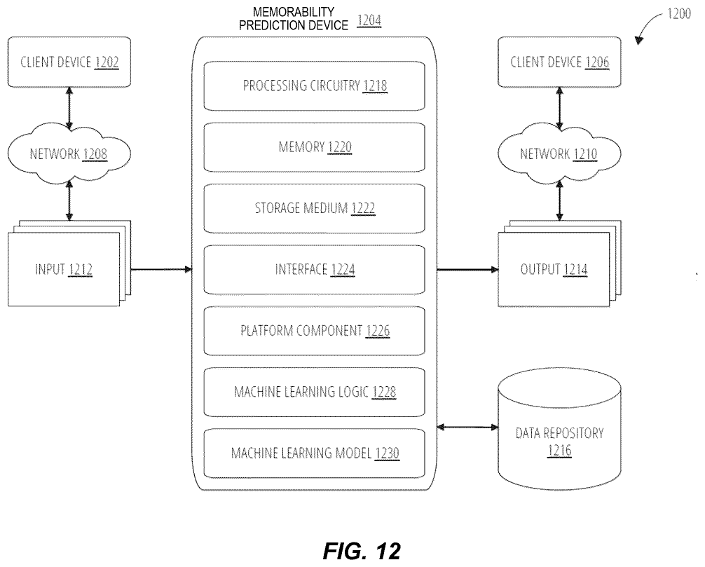

FIG. 12 illustrates an embodiment of a system 1200. The system 1200 is suitable for implementing one or more embodiments as described herein. In one embodiment, for example, the system 1200 is an AI/ML system suitable for processing visual content to determine a memorability prediction for the visual content.

The system 1200 comprises a set of M devices, where M is any positive integer. FIG. 12 depicts three devices (M=3), including a client device 1202, an memorability prediction device 1204, and a client device 1206. The memorability prediction device 1204 communicates information with the client device 1202 and the client device 1206 over a network 1208 and a network 1210, respectively. The information includes input 1212 from the client device 1202 and output 1214 to the client device 1206, or vice-versa. In one alternative, the input 1212 and the output 1214 are communicated between the same client device 1202 or client device 1206. In another alternative, the input 1212 and the output 1214 are stored in a data repository 1216. In yet another alternative, the input 1212 and the output 1214 are communicated via a platform component 1226 of the memorability prediction device 1204, such as an input/output (I/O) device (e.g., a touchscreen, a microphone, a speaker, etc.).

As depicted in FIG. 12, the memorability prediction device 1204 includes processing circuitry 1218, a memory 1220, a storage medium 1222, an interface 1224, a platform component 1226, ML logic 1228, and an ML model 1230. In some implementations, the memorability prediction device 1204 includes other components or devices as well. Examples for software elements and hardware elements of the memorability prediction device 1204 are described in more detail with reference to a computing architecture 1700 as depicted in FIG. 17. Embodiments are not limited to these examples.

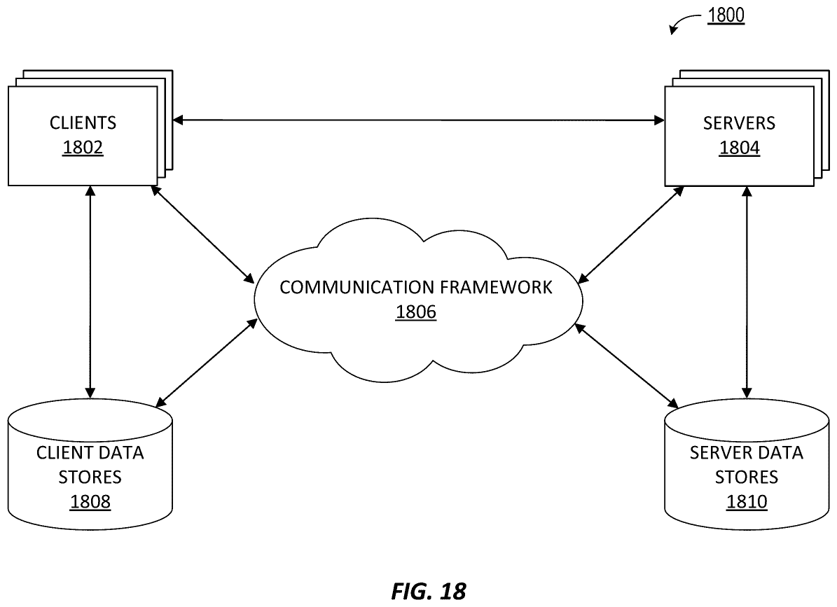

The memorability prediction device 1204 is generally arranged to receive an input 1212, process the input 1212 via one or more AI/ML techniques, and send an output 1214. In one example, the input 1212 is digital visual content, such as a video or image. The memorability prediction device 1204 receives the input 1212 from the client device 1202 via the network 1208, the client device 1206 via the network 1210, the platform component 1226 (e.g., a touchscreen as a text command or microphone as a voice command), the memory 1220, the storage medium 1222 or the data repository 1216. The memorability prediction device 1204 sends the output 1214 to the client device 1202 via the network 1208, the client device 1206 via the network 1210, the platform component 1226 (e.g., a touchscreen to present text, graphic or video information or speaker to reproduce audio information), the memory 1220, the storage medium 1222 or the data repository 1216. The output 1214 includes one or more recommendation style elements. Examples for the software elements and hardware elements of the network 1208 and the network 1210 are described in more detail with reference to a communications architecture 1800 as depicted in FIG. 18. Embodiments are not limited to these examples.

The memorability prediction device 1204 includes ML logic 1228 and an ML model 1230 to implement various AI/ML techniques for various AI/ML tasks. The ML logic 1228 receives the input 1212, and processes the input 1212 using the ML model 1230, e.g., identifies style element candidates that can be implemented in a design. The ML model 1230 performs inferencing operations to generate an inference for a specific task from the input 1212. In some cases, the inference is part of the output 1214. The output 1214 is used by the client device 1202, the memorability prediction device 1204, or the client device 1206 to perform subsequent actions in response to the output 1214.

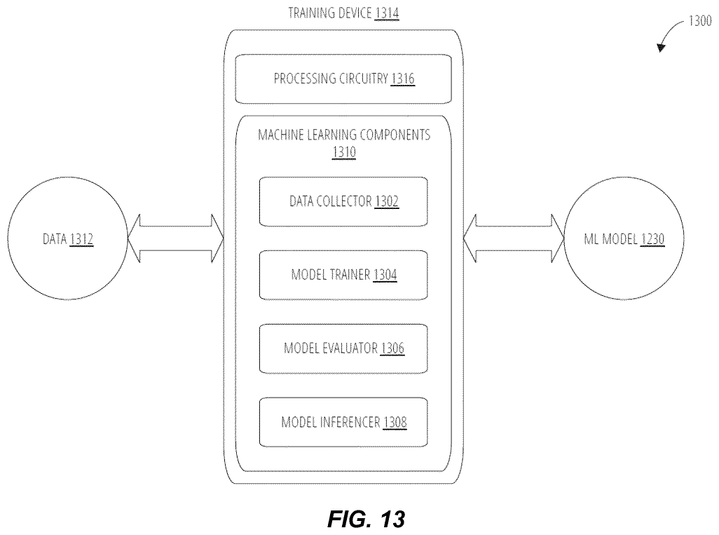

In various embodiments, the ML model 1230 is a trained ML model 1230 using a set of training operations. An example of training operations to train the ML model 1230 is described with reference to FIG. 13.

FIG. 13 illustrates an apparatus 1300. The apparatus 1300 depicts a training device 1314 suitable to generate a trained ML model 1230 for the memorability prediction device 1204 of the system 1200. As depicted in FIG. 13, the training device 1314 includes a processing circuitry 1316 and a set of ML components 1310 to support various AI/ML techniques, such as a data collector 1302, a model trainer 1304, a model evaluator 1306 and a model inferencer 1308. In one example, the training device 1314 performs the training operations, as discussed in FIG. 1 and/or FIG. 3.

In general, the data collector 1302 collects data 1312 from one or more data sources to use as training data for the ML model 1230, long-term memorability data (e.g., reference 912 of FIG. 9). The data collector 1302 collects different types of data 1312, such as text information, audio information, image information, video information, graphic information, and so forth. The model trainer 1304 receives as input the collected data and uses a portion of the collected data as test data for an AI/ML algorithm to train the ML model 1230. The model evaluator 1306 evaluates and improves the trained ML model 1230 using a portion of the collected data as test data to test the ML model 1230. The model evaluator 1306 also uses feedback information from the deployed ML model 1230. The model inferencer 1308 implements the trained ML model 1230 to receive as input new unseen data, generate one or more inferences on the new data, and output a result such as an alert, a recommendation or other post-solution activity.

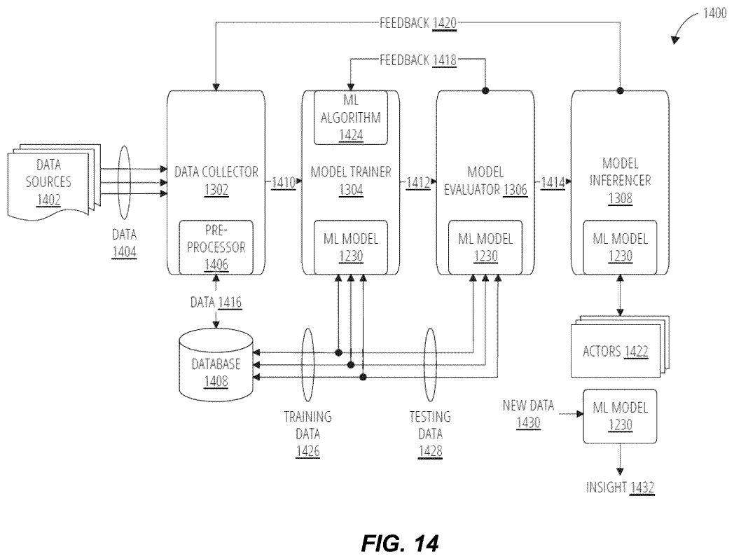

An exemplary AI/ML architecture for the ML components 1310 is described in more detail with reference to FIG. 14.

FIG. 14 illustrates an artificial intelligence architecture 1400 suitable for use by the training device 1314 to generate the ML model 1230 for deployment by the memorability prediction device 1204. The artificial intelligence architecture 1400 is an example of a system suitable for implementing various AI techniques and/or ML techniques to perform various inferencing tasks on behalf of the various devices of the system 1200.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the artificial intelligence architecture 1400 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 1230, evaluate performance of the trained ML model 1230, and deploy the tested ML model 1230 as the trained ML model 1230 in a production environment, and continuously monitor and maintain it.

The ML model 1230 is a mathematical construct used to predict outcomes based on a set of input data. The ML model 1230 is trained using large volumes of training data 1426, and it can recognize patterns and trends in the training data 1426 to make accurate predictions. The ML model 1230 is derived from an ML algorithm 1424 (e.g., a neural network, decision tree, support vector machine, etc.). A data set is fed into the ML algorithm 1424 which trains an ML model 1230 to “learn” a function that produces mappings between a set of inputs and a set of outputs with a reasonably high accuracy. Given a sufficiently large enough set of inputs and outputs, the ML algorithm 1424 finds the function for a given task. This function can produce the correct output for input that it has not seen during training. A data scientist prepares the mappings, selects and tunes the ML algorithm 1424, and evaluates the resulting model performance. Once the ML logic 1228 is sufficiently accurate on test data, it can be deployed for production use.

The ML algorithm 1424 includes any ML algorithm suitable for a given AI task. Examples of ML algorithms includes supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1424 of the artificial intelligence architecture 1400 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 14, the artificial intelligence architecture 1400 includes a set of data sources 1402 to source data 1404 for the artificial intelligence architecture 1400. Data sources 1402 includes any device capable generating, processing, storing or managing data 1404 suitable for a ML system. Examples of data sources 1402 include without limitation databases, web scraping, sensors and Internet of Things (IoT) devices, image and video cameras, audio devices, text generators, publicly available databases, private databases, and many other data sources 1402. The data sources 1402 may be remote from the artificial intelligence architecture 1400 and accessed via a network, local to the artificial intelligence architecture 1400 an accessed via a network interface, or may be a combination of local and remote data sources 1402.

The data sources 1402 source difference types of data 1404. By way of example and not limitation, the data 1404 includes structured data from relational databases, such as customer profiles, transaction histories, or product inventories. The data 1404 includes unstructured data from websites such as customer reviews, news articles, social media posts, or product specifications. The data 1404 includes data from temperature sensors, motion detectors, and smart home appliances. The data 1404 includes image data from medical images, security footage, or satellite images. The data 1404 includes audio data from speech recognition, music recognition, or call centers. The data 1404 includes text data from emails, chat logs, customer feedback, news articles or social media posts. The data 1404 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1404 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1402 are communicatively coupled to a data collector 1302. The data collector 1302 gathers relevant data 1404 from the data sources 1402. Once collected, the data collector 1302 may use a pre-processor 1406 to make the data 1404 suitable for analysis. This involves data cleaning, transformation, and feature engineering. Data preprocessing is a critical step in ML as it directly impacts the accuracy and effectiveness of the ML model 1230. The pre-processor 1406 receives the data 1404 as input, processes the data 1404, and outputs pre-processed data 1416 for storage in a database 1408. Examples for the database 1408 includes a hard drive, solid state storage, and/or random access memory (RAM).

The data collector 1302 is communicatively coupled to a model trainer 1304. The model trainer 1304 performs AI/ML model training, validation, and testing which may generate model performance metrics as part of the model testing procedure. The model trainer 1304 receives the pre-processed data 1416 as input 1410 or via the database 1408. The model trainer 1304 implements a suitable ML algorithm 1424 to train an ML model 1230 on a set of training data 1426 from the pre-processed data 1416. The training process involves feeding the pre-processed data 1416 into the ML algorithm 1424 to produce or optimize an ML model 1230. The training process adjusts its parameters until it achieves an initial level of satisfactory performance.

The model trainer 1304 is communicatively coupled to a model evaluator 1306. After an ML model 1230 is trained, the ML model 1230 needs to be evaluated to assess its performance. This is done using various metrics such as accuracy, precision, recall, and F1 score. The model trainer 1304 outputs the ML model 1230, which is received as input 1410 or from the database 1408. The model evaluator 1306 receives the ML model 1230 as input 1412, and it initiates an evaluation process to measure performance of the ML model 1230. The evaluation process includes providing feedback 1418 to the model trainer 1304. The model trainer 1304 re-trains the ML model 1230 to improve performance in an iterative manner.

The model evaluator 1306 is communicatively coupled to a model inferencer 1308. The model inferencer 1308 provides AI/ML model inference output (e.g., inferences, predictions or decisions). Once the ML model 1230 is trained and evaluated, it is deployed in a production environment where it is used to make predictions on new data. The model inferencer 1308 receives the evaluated ML model 1230 as input 1414. The model inferencer 1308 uses the evaluated ML model 1230 to produce insights or predictions on real data, which is deployed as a final production ML model 1230. The inference output of the ML model 1230 is use case specific. The model inferencer 1308 also performs model monitoring and maintenance, which involves continuously monitoring performance of the ML model 1230 in the production environment and making any necessary updates or modifications to maintain its accuracy and effectiveness. The model inferencer 1308 provides feedback 1418 to the data collector 1302 to train or re-train the ML model 1230. The feedback 1418 includes model performance feedback information, which is used for monitoring and improving performance of the ML model 1230.

Some or all of the model inferencer 1308 is implemented by various actors 1422 in the artificial intelligence architecture 1400, including the ML model 1230 of the memorability prediction device 1204, for example. The actors 1422 use the deployed ML model 1230 on new data to make inferences or predictions for a given task, and output an insight 1432. The actors 1422 implement the model inferencer 1308 locally, or remotely receives outputs from the model inferencer 1308 in a distributed computing manner. The actors 1422 trigger actions directed to other entities or to itself. The actors 1422 provide feedback 1420 to the data collector 1302 via the model inferencer 1308. The feedback 1420 comprise data needed to derive training data, inference data or to monitor the performance of the ML model 1230 and its impact to the network through updating of key performance indicators (KPIs) and performance counters.

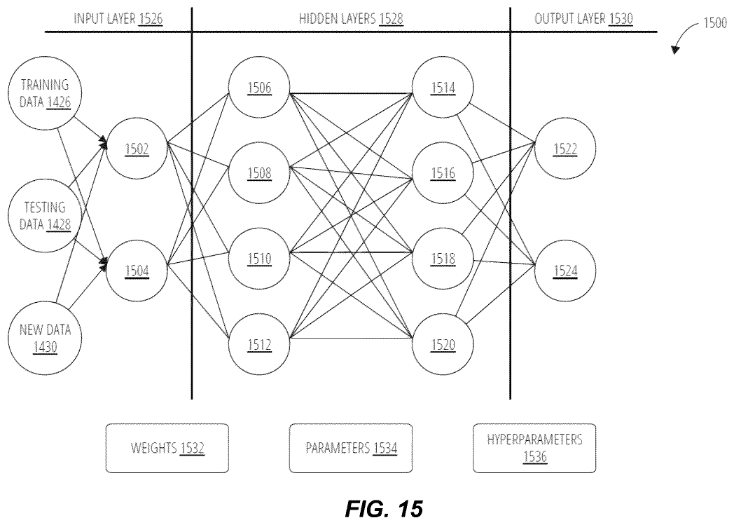

As previously described with reference to FIGS. 1-5, the systems 1200, 1300 implement some or all of the artificial intelligence architecture 1400 to support various use cases and solutions for various AI/ML tasks. In various embodiments, the training device 1314 of the apparatus 1300 uses the artificial intelligence architecture 1400 to generate and train the ML model 1230 for use by the memorability prediction device 1204 for the system 1200. In one embodiment, for example, the training device 1314 may train the ML model 1230 as a neural network, as described in more detail with reference to FIG. 15. Other use cases and solutions for AI/ML are possible as well, and embodiments are not limited in this context.

FIG. 15 illustrates an embodiment of an artificial neural network 1500. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1500 comprises multiple node layers, containing an input layer 1526, one or more hidden layers 1528, and an output layer 1530. Each layer comprises one or more nodes, such as nodes 1502 to 1524. As depicted in FIG. 15, for example, the input layer 1526 has nodes 1502, 1504. The artificial neural network 1500 has two hidden layers 1528, with a first hidden layer having nodes 1506, 1508, 1510 and 1512, and a second hidden layer having nodes 1514, 1516, 1518 and 1520. The artificial neural network 1500 has an output layer 1530 with nodes 1522, 1524. Each node 1502 to 1524 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1500 relies on training data 1426 to learn and improve accuracy over time. However, once the artificial neural network 1500 is fine-tuned for accuracy, and tested on testing data 1428, the artificial neural network 1500 is ready to classify and cluster new data 1430 at a high velocity. Tasks in speech recognition or image recognition can take minutes versus hours when compared to the manual identification by human experts.

Each individual node 1502 to 424 is a linear regression model, composed of input data, weights, a bias (or threshold), and an output. The linear regression model may have a formula the same or similar to the following Equation (1):

$$\sum {w}_{i} {x}_{i} + bias = {w}_{1} {x}_{1} + {w}_{2} {x}_{2} + {w}_{3} {x}_{3} + bias$$

$$output = f ( x ) = 1 if \sum {w}_{1} {x}_{1} + b >= 0 ;$$

$$0 if \sum {w}_{1} {x}_{1} + b < 0.$$

Once an input layer 1526 is determined, a set of weights 1532 are assigned. The weights 1532 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1500 as a feedforward network.

In one embodiment, the artificial neural network 1500 leverages sigmoid neurons, which are distinguished by having values between 0 and 1. Since the artificial neural network 1500 behaves similarly to a decision tree, cascading data from one node to another, having x values between 0 and 1 will reduce the impact of any given change of a single variable on the output of any given node, and subsequently, the output of the artificial neural network 1500.

The artificial neural network 1500 has many practical use cases, like image recognition, speech recognition, text recognition or classification. The artificial neural network 1500 leverages supervised learning, or labeled datasets, to train the algorithm. As the model is trained, its accuracy is measured using a cost (or loss) function. This is also commonly referred to as the mean squared error (MSE). An example of a cost function is shown in the following Equation (2):

$$Cost Function = MSE = \frac{1}{2 m} {\sum }_{i = 1}^{m} {( - {y}_{i} )}^{2} \to MIN ,$$

where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1534 of the model adjust to gradually converge at the minimum.

In one embodiment, the artificial neural network 1500 is feedforward, meaning it flows in one direction only, from input to output. In one embodiment, the artificial neural network 1500 uses backpropagation. Backpropagation is when the artificial neural network 1500 moves in the opposite direction from output to input. Backpropagation allows calculation and attribution of errors associated with each neuron 1502 to 1524, thereby allowing adjustment to fit the parameters 1534 of the ML model 1230 appropriately.

The artificial neural network 1500 is implemented as different neural networks depending on a given task. Neural networks are classified into different types, which are used for different purposes. In one embodiment, the artificial neural network 1500 is implemented as a feedforward neural network, or multi-layer perceptrons (MLPs), comprised of an input layer 1526, hidden layers 1528, and an output layer 1530. While these neural networks are also commonly referred to as MLPs, they are actually comprised of sigmoid neurons, not perceptrons, as most real-world problems are nonlinear. Trained data 1404 usually is fed into these models to train them, and they are the foundation for computer vision, natural language processing, and other neural networks. In one embodiment, the artificial neural network 1500 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1500 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1500 is implemented as any type of neural network suitable for a given operational task of system 1200, and the MLP, CNN, GNN, HNN, HGNN, and RNN are merely a few examples. Embodiments are not limited in this context.

The artificial neural network 1500 includes a set of associated parameters 1534. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1500 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 1536. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

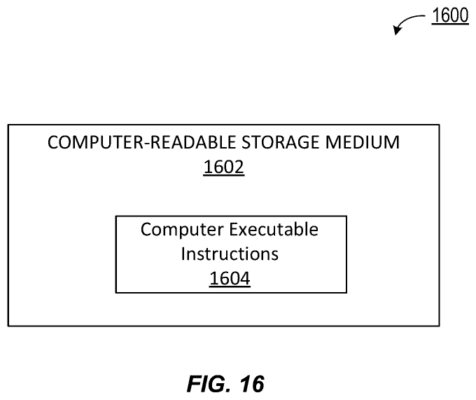

FIG. 16 illustrates an apparatus 1600. Apparatus 1600 comprises any non-transitory computer-readable storage medium 1602 or machine-readable storage medium, such as an optical, magnetic or semiconductor storage medium. In various embodiments, apparatus 1600 comprises an article of manufacture or a product. In some embodiments, the computer-readable storage medium 1602 stores computer executable instructions with which one or more processing devices or processing circuitry can execute. For example, computer executable instructions 1604 includes instructions to implement operations described with respect to any logic flows described herein. Examples of computer-readable storage medium 1602 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1604 include any suitable type of code, such as source code, compiled code, interpreted code, executable code, static code, dynamic code, object-oriented code, visual code, and the like.

FIG. 17 illustrates an embodiment of a computing architecture 1700. Computing architecture 1700 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1700 has a single processor with one core or more than one processor. Note that the term “processor” refers to a processor with a single core or a processor package with multiple processor cores. In at least one embodiment, the computing architecture 1700 is representative of the components of the system 1200. More generally, the computing architecture 1700 implements all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1700. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 17, computing architecture 1700 comprises a system-on-chip (SoC) 1702 for mounting platform components. System-on-chip (SoC) 1702 is a point-to-point (P2P) interconnect platform that includes a first processor 1704 and a second processor 1706 coupled via a point-to-point interconnect 1770 such as an Ultra Path Interconnect (UPI). In other embodiments, the computing architecture 1700 is another bus architecture, such as a multi-drop bus. Furthermore, each of processor 1704 and processor 1706 are processor packages with multiple processor cores including core(s) 1708 and core(s) 1710, respectively. While the computing architecture 1700 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1704 and chipset 1732. Some platforms include additional components and some platforms include sockets to mount the processors and/or the chipset. Furthermore, some platforms do not have sockets (e.g. SoC, or the like). Although depicted as a SoC 1702, one or more of the components of the SoC 1702 are included in a single die package, a multi-chip module (MCM), a multi-die package, a chiplet, a bridge, and/or an interposer. Therefore, embodiments are not limited to a SoC.

The processor 1704 and processor 1706 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1704 and/or processor 1706. Additionally, the processor 1704 need not be identical to processor 1706.

Processor 1704 includes an integrated memory controller (IMC) 1720 and point-to-point (P2P) interface 1724 and P2P interface 1728. Similarly, the processor 1706 includes an IMC 1722 as well as P2P interface 1726 and P2P interface 1730. IMC 1720 and IMC 1722 couple the processor 1704 and processor 1706, respectively, to respective memories (e.g., memory 1716 and memory 1718). Memory 1716 and memory 1718 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1716 and the memory 1718 locally attach to the respective processors (i.e., processor 1704 and processor 1706). In other embodiments, the main memory couple with the processors via a bus and shared memory hub. Processor 1704 includes registers 1712 and processor 1706 includes registers 1714.

Computing architecture 1700 includes chipset 1732 coupled to processor 1704 and processor 1706. Furthermore, chipset 1732 are coupled to storage device 1750, for example, via an interface (I/F) 1738. The I/F 1738 may be, for example, a Peripheral Component Interconnect-enhanced (PCIe) interface, a Compute Express Link® (CXL) interface, or a Universal Chiplet Interconnect Express (UCIe) interface. Storage device 1750 stores instructions executable by circuitry of computing architecture 1700 (e.g., processor 1704, processor 1706, GPU 1748, accelerator 1754, vision processing unit 1756, or the like). For example, storage device 1750 can store instructions for the client device 1202, the client device 1206, the memorability prediction device 1204, the training device 1314, or the like.

Processor 1704 couples to the chipset 1732 via P2P interface 1728 and P2P 1734 while processor 1706 couples to the chipset 1732 via P2P interface 1730 and P2P 1736. Direct media interface (DMI) 1776 and DMI 1778 couple the P2P interface 1728 and the P2P 1734 and the P2P interface 1730 and P2P 1736, respectively. DMI 1776 and DMI 1778 is a high-speed interconnect that facilitates, e.g., eight Giga Transfers per second (GT/s) such as DMI 3.0. In other embodiments, the processor 1704 and processor 1706 interconnect via a bus.

The chipset 1732 comprises a controller hub such as a platform controller hub (PCH). The chipset 1732 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1732 comprises more than one controller hub such as a chipset with a memory controller hub, a graphics controller hub, and an input/output (I/O) controller hub.

In the depicted example, chipset 1732 couples with a trusted platform module (TPM) 1744 and UEFI, BIOS, FLASH circuitry 1746 via I/F 1742. The TPM 1744 is a dedicated microcontroller designed to secure hardware by integrating cryptographic keys into devices. The UEFI, BIOS, FLASH circuitry 1746 may provide pre-boot code. The I/F 1742 may also be coupled to a network interface circuit (NIC) 1780 for connections off-chip.

Furthermore, chipset 1732 includes the I/F 1738 to couple chipset 1732 with a high-performance graphics engine, such as, graphics processing circuitry or a graphics processing unit (GPU) 1748. In other embodiments, the computing architecture 1700 includes a flexible display interface (FDI) (not shown) between the processor 1704 and/or the processor 1706 and the chipset 1732. The FDI interconnects a graphics processor core in one or more of processor 1704 and/or processor 1706 with the chipset 1732.

The computing architecture 1700 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1754 and/or vision processing unit 1756 are coupled to chipset 1732 via I/F 1738. The accelerator 1754 is representative of any type of accelerator device (e.g., a data streaming accelerator, cryptographic accelerator, cryptographic co-processor, an offload engine, etc.). One example of an accelerator 1754 is the Intel® Data Streaming Accelerator (DSA). The accelerator 1754 is a device including circuitry to accelerate copy operations, data encryption, hash value computation, data comparison operations (including comparison of data in memory 1716 and/or memory 1718), and/or data compression. Examples for the accelerator 1754 include a USB device, PCI device, PCIe device, CXL device, UCIe device, and/or an SPI device. The accelerator 1754 also includes circuitry arranged to execute machine learning (ML) related operations (e.g., training, inference, etc.) for ML models. Generally, the accelerator 1754 is specially designed to perform computationally intensive operations, such as hash value computations, comparison operations, cryptographic operations, and/or compression operations, in a manner that is more efficient than when performed by the processor 1704 or processor 1706. Because the load of the computing architecture 1700 includes hash value computations, comparison operations, cryptographic operations, and/or compression operations, the accelerator 1754 greatly increases performance of the computing architecture 1700 for these operations.

The accelerator 1754 includes one or more dedicated work queues and one or more shared work queues (each not pictured). Generally, a shared work queue is stores descriptors submitted by multiple software entities. The software is any type of executable code, such as a process, a thread, an application, a virtual machine, a container, a microservice, etc., that share the accelerator 1754. For example, the accelerator 1754 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1754 via a non-posted write (e.g., a deferred memory write (DMWr)). One example of an instruction that atomically submits a work descriptor to the shared work queue of the accelerator 1754 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1754. The dedicated work queue may accept job submissions via commands such as the movdir64b instruction.

Various I/O devices 1760 and display 1752 couple to the bus 1772, along with a bus bridge 1758 which couples the bus 1772 to a second bus 1774 and an I/F 1740 that connects the bus 1772 with the chipset 1732. In one embodiment, the second bus 1774 is a low pin count (LPC) bus. Various input/output (I/O) devices couple to the second bus 1774 including, for example, a keyboard 1762, a mouse 1764 and communication devices 1766.

Furthermore, an audio I/O 1768 couples to second bus 1774. Many of the I/O devices 1760 and communication devices 1766 reside on the system-on-chip (SoC) 1702 while the keyboard 1762 and the mouse 1764 are add-on peripherals. In other embodiments, some or all the I/O devices 1760 and communication devices 1766 are add-on peripherals and do not reside on the system-on-chip (SoC) 1702.

FIG. 18 illustrates a block diagram of an exemplary communications architecture 1800 suitable for implementing various embodiments as previously described. The communications architecture 1800 includes various common communications elements, such as a transmitter, receiver, transceiver, radio, network interface, baseband processor, antenna, amplifiers, filters, power supplies, and so forth. The embodiments, however, are not limited to implementation by the communications architecture 1800.

As shown in FIG. 18, the communications architecture 1800 includes one or more clients 1802 and servers 1804. The clients 1802 and the servers 1804 are operatively connected to one or more respective client data stores 1808 and server data stores 1810 that can be employed to store information local to the respective clients 1802 and servers 1804, such as cookies and/or associated contextual information.

The clients 1802 and the servers 1804 communicate information between each other using a communication framework 1806. The communication framework 1806 implements any well-known communications techniques and protocols. The communication framework 1806 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1806 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/1200/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1802 and the servers 1804. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

In one embodiment, a computer-implemented method may include generating, using an image processing module, language tokens representing an item of visual digital content in a language space, the language tokens may include visual encoding tokens computed by a visual encoding model, and verbalization tokens computed by a verbalization model; and determining, using a memorability prediction module, a memorability prediction for the item of digital content via providing the language tokens as input to a prediction model, the prediction module may include a natural language processing (NLP) model trained using at least one memorability dataset to simulate memorability of digital visual content based on the language tokens, the memorability prediction may include a probability of the digital visual content being remembered by a viewer.

In some embodiments of the computer-implemented method, the visual encoding model may include: a vision transformer (ViT) encoder trained to generate visual embeddings from the item of digital visual content, and a querying transformer model trained to receive the visual embeddings as input and to generate language embeddings as output, the language embeddings may include a description of the item of digital visual content in the language space for use by the NLP model.

In various embodiments of the computer-implemented method, the verbalization model may include at least one perception tool configured to generate text through verbalization of at least one feature of the item of digital visual content, the at least one perception tool may include one or more of optical character recognition (OCR), audio and speech recognition (ASR), text-to-speech, object detection, emotion detection, color detection, or aesthetics detection.

In exemplary embodiments of the computer-implemented method, the at least one memorability data set may include a long-term memory dataset generated based on a long-term memorability study of viewer memorability of digital visual content over a long-term duration of at least 1 day to about 5 days.

In some embodiments of the computer-implemented method, the at least one memorability data set may include experimental information indicating properties of a study that is a source of real-world data of the memorability data set.

In various embodiments of the computer-implemented method, the memorability prediction may include a memorability score, and the NLP model trained to determine at least one memorability factor contributing to the memorability score.

In some embodiments of the computer-implemented method, the method may include sending the memorability score and the at least one memorability factor to a network interface for presentation on a graphical user interface (GUI) of an electronic display of a client device.

In various embodiments of the computer-implemented method, the NLP model may include a pre-trained large language model (LLM) and the language tokens including language input optimized for the pre-trained LLM.

In one embodiment, a system may include at least one processor; and at least one non-transitory storage media storing instructions, that when executed by the at least one processor, cause the at least one processor to perform operations including: performing a first training, using a model configuration module of the at least one processor, a natural language processing (NLP) model using a first training data set may include a visual encoder embeddings training set may include visual encoding tokens computed by a visual encoding model based on a training set of digital visual content, the first training to configure the NLP model to process visual information of digital visual content transformed into a language space, and performing a second training, using the model configuration module, of the NLP model using a second training data set including a long-term memorability training set including real-world content memorability study results analyzing long-term viewer recall of the digital visual content, the second training to configure the NLP model to simulate viewer memorability of digital visual content transformed into the language space.

In some embodiments of the system, the long-term memorability training set may include experimental information indicating properties of the real-world content memorability study.

In various embodiments of the system, the instructions, when executed by the at least one processor, may cause the at least one processor to simulate the viewer memorability by determining a memorability prediction for an item of digital content input to the NLP model.

In some embodiments of the system, the instructions, when executed by the at least one processor, may cause the at least one processor to generate, using an image processing module, language tokens representing an item of visual digital content in the language space, the language tokens may include: visual encoding tokens computed by a visual encoding model, and verbalization tokens computed by a verbalization model.

In exemplary embodiments of the system, the visual encoding model may include: a vision transformer (ViT) encoder trained to generate visual embeddings from the item of digital visual content, and a querying transformer model trained to receive the visual embeddings as input and to generate language embeddings as output, the language embeddings may include a description of the item of digital visual content in the language space for use by the NLP model.

In various embodiments of the system, the verbalization model may include at least one perception tool configured to generate text through verbalization of at least one feature of the item of digital visual content, the at least one perception tool may include one or more of optical character recognition (OCR), audio and speech recognition (ASR), text-to-speech, object detection, emotion detection, color detection, or aesthetics detection.

In one embodiment, a non-transitory computer-readable medium storing executable instructions, which when executed by one or more processing devices, cause the one or more processing devices to perform operations including: generating, using an image processing module, language tokens representing an item of visual digital content in a language space, the language tokens may include: visual encoding tokens computed by a visual encoding model, and verbalization tokens computed by a verbalization model; and determining, using a memorability prediction module, a memorability prediction for the item of digital content via providing the language tokens as input to a prediction model, the prediction module may include a natural language processing (NLP) model trained using at least one memorability dataset to simulate memorability of digital visual content based on the language tokens, the memorability prediction may include a probability of the digital visual content being remembered by a viewer.

In some embodiments of the non-transitory computer-readable medium, the visual encoding model may include: a vision transformer (ViT) encoder trained to generate visual embeddings from the item of digital visual content, and a querying transformer model trained to receive the visual embeddings as input and to generate language embeddings as output, the language embeddings may include a description of the item of digital visual content in the language space for use by the NLP model.

In various embodiments of the non-transitory computer-readable medium, the verbalization model may include at least one perception tool configured to generate text through verbalization of at least one feature of the item of digital visual content, the at least one perception tool may include one or more of optical character recognition (OCR), audio and speech recognition (ASR), text-to-speech, object detection, emotion detection, color detection, or aesthetics detection.

In some embodiments of the non-transitory computer-readable medium, the at least one memorability data set may include a long-term memory dataset generated based on a long-term memorability study of viewer memorability of digital visual content over a long-term duration of at least 1 day to about 5 days.

In exemplary embodiments of the non-transitory computer-readable medium, the memorability prediction may include a memorability score, and the NLP model trained to determine at least one memorability factor contributing to the memorability score.

In various embodiments of the non-transitory computer-readable medium, the instructions, when executed by the one or more processing devices, may cause the one or more processing devices to perform operations may include sending the memorability score and the at least one memorability factor to a network interface for presentation on a graphical user interface (GUI) of an electronic display of a client device.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description and the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects. The following examples pertain to further embodiments, from which numerous permutations and configurations will be apparent.

What is claimed is:

1. A computer-implemented method, comprising:
generating, using an image processing module, language tokens representing an item of visual digital content in a language space, the language tokens comprising:
visual encoding tokens computed by a visual encoding model, and
verbalization tokens computed by a verbalization model; and
determining, using a memorability prediction module, a memorability prediction for the item of digital content via providing the language tokens as input to a prediction model, the prediction module comprising a natural language processing (NLP) model trained using at least one memorability dataset to simulate memorability of digital visual content based on the language tokens, the memorability prediction comprising a probability of the digital visual content being remembered by a viewer.

2. The computer-implemented method of claim 1, the visual encoding model comprising:
a vision transformer (ViT) encoder trained to generate visual embeddings from the item of digital visual content, and
a querying transformer model trained to receive the visual embeddings as input and to generate language embeddings as output, the language embeddings comprising a description of the item of digital visual content in the language space for use by the NLP model.

3. The computer-implemented method of claim 1, the verbalization model comprising at least one perception tool configured to generate text through verbalization of at least one feature of the item of digital visual content, the at least one perception tool comprising one or more of optical character recognition (OCR), audio and speech recognition (ASR), text-to-speech, object detection, emotion detection, color detection, or aesthetics detection.

4. The computer-implemented method of claim 1, the at least one memorability data set comprising a long-term memory dataset generated based on a long-term memorability study of viewer memorability of digital visual content over a long-term duration of at least 1 day to about 5 days.

5. The computer-implemented method of claim 1, the at least one memorability data set comprising experimental information indicating properties of a study that is a source of real-world data of the memorability data set.

6. The computer-implemented method of claim 1, the memorability prediction comprising a memorability score, and the NLP model trained to determine at least one memorability factor contributing to the memorability score.

7. The computer-implemented method of claim 6, comprising sending the memorability score and the at least one memorability factor to a network interface for presentation on a graphical user interface (GUI) of an electronic display of a client device.

8. The computer-implemented method of claim 1, the NLP model comprising a pre-trained large language model (LLM) and the language tokens comprising language input optimized for the pre-trained LLM.

9. A system, comprising:
at least one processor; and
at least one non-transitory storage media storing instructions, that when executed by the at least one processor, cause the at least one processor to perform operations including:
performing a first training, using a model configuration module of the at least one processor, a natural language processing (NLP) model using a first training data set comprising a visual encoder embeddings training set comprising visual encoding tokens computed by a visual encoding model based on a training set of digital visual content, the first training to configure the NLP model to process visual information of digital visual content transformed into a language space, and
performing a second training, using the model configuration module, of the NLP model using a second training data set comprising a long-term memorability training set comprising real-world content memorability study results analyzing long-term viewer recall of the digital visual content, the second training to configure the NLP model to simulate viewer memorability of digital visual content transformed into the language space.

10. The system of claim 9, the long-term memorability training set comprising experimental information indicating properties of the real-world content memorability study.

11. The system of claim 9, the instructions, when executed by the at least one processor, to cause the at least one processor to simulate the viewer memorability by determining a memorability prediction for an item of digital content input to the NLP model.

12. The system of claim 9, the instructions, when executed by the at least one processor, to cause the at least one processor to generate, using an image processing module, language tokens representing an item of visual digital content in the language space, the language tokens comprising:
visual encoding tokens computed by a visual encoding model, and
verbalization tokens computed by a verbalization model.

13. The system of claim 12, the visual encoding model comprising:
a vision transformer (ViT) encoder trained to generate visual embeddings from the item of digital visual content, and
a querying transformer model trained to receive the visual embeddings as input and to generate language embeddings as output, the language embeddings comprising a description of the item of digital visual content in the language space for use by the NLP model.

14. The system of claim 12, the verbalization model comprising at least one perception tool configured to generate text through verbalization of at least one feature of the item of digital visual content, the at least one perception tool comprising one or more of optical character recognition (OCR), audio and speech recognition (ASR), text-to-speech, object detection, emotion detection, color detection, or aesthetics detection.

15. A non-transitory computer-readable medium storing executable instructions, which when executed by one or more processing devices, cause the one or more processing devices to perform operations comprising:
generating, using an image processing module, language tokens representing an item of visual digital content in a language space, the language tokens comprising:
visual encoding tokens computed by a visual encoding model, and
verbalization tokens computed by a verbalization model; and
determining, using a memorability prediction module, a memorability prediction for the item of digital content via providing the language tokens as input to a prediction model, the prediction module comprising a natural language processing (NLP) model trained using at least one memorability dataset to simulate memorability of digital visual content based on the language tokens, the memorability prediction comprising a probability of the digital visual content being remembered by a viewer.

16. The non-transitory computer-readable medium of claim 15, the visual encoding model comprising:
a vision transformer (ViT) encoder trained to generate visual embeddings from the item of digital visual content, and
a querying transformer model trained to receive the visual embeddings as input and to generate language embeddings as output, the language embeddings comprising a description of the item of digital visual content in the language space for use by the NLP model.

17. The non-transitory computer-readable medium of claim 15, the verbalization model comprising at least one perception tool configured to generate text through verbalization of at least one feature of the item of digital visual content, the at least one perception tool comprising one or more of optical character recognition (OCR), audio and speech recognition (ASR), text-to-speech, object detection, emotion detection, color detection, or aesthetics detection.

18. The non-transitory computer-readable medium of claim 15, the at least one memorability data set comprising a long-term memory dataset generated based on a long-term memorability study of viewer memorability of digital visual content over a long-term duration of at least 1 day to about 5 days.

19. The non-transitory computer-readable medium of claim 15, the memorability prediction comprising a memorability score, and the NLP model trained to determine at least one memorability factor contributing to the memorability score.

20. The non-transitory computer-readable medium of claim 19, the instructions, when executed by the one or more processing devices, to cause the one or more processing devices to perform operations comprising sending the memorability score and the at least one memorability factor to a network interface for presentation on a graphical user interface (GUI) of an electronic display of a client device.
